(19) United States
(12) Patent Application Publication
(10) Pub. No.: US 2011/0248914 A1
(43) Pub. Date: Oct. 13, 2011

(54) System and Method for Virtual Touch Typing

(76) Inventor: Alan B. Sherr, Cambridge, MA (US)

(21) Appl. No.: 13/083,304

(22) Filed: Apr. 8, 2011

Related U.S. Application Data
(60) Provisional application No. 61/322,869, filed on Apr. 11, 2010.

(51) Int. Cl. G09G 5/00

(52) U.S. Cl. 345/156

(57) ABSTRACT

Systems, methods, and products are described for enabling a user to enter data into a device without a keyboard. A virtual keyboard in accordance with the invention may include a sensor to detect actual or intended finger movements or other changes in the user's physiology, an element that generates a sequence of ambiguous pseudo-words based on the physiological changes, and a translator that translates the pseudo-words into words in a natural language and provides the natural language words to the device or to a data storage unit. The device typically may be a computer, electronic notepad, personal digital assistant, telephone, or other electronic device.

### RELATED APPLICATION

The present application claims priority from U.S. Provisional Patent Application Ser. No. 61/322,869, entitled “System and Method for Virtual Touch Typing,” filed Apr. 11, 2010, which is hereby incorporated herein by reference in its entirety for all purposes.

### FIELD OF THE INVENTION

The present invention relates to the field of data entry for computers, personal digital assistants, electronic notepads, telephones, and other devices. In particular, the present invention relates to systems, methods, and products for entering data by typing without the use of a keyboard.

### BACKGROUND

Conventionally, alphanumeric data is commonly entered into computers, personal digital assistants, electronic notepads, telephones, and other electronic devices by using a keyboard containing keys representing letters, numbers, punctuation, and special characters and controls. For example, in the standard QWERTY keyboard used to input English language text, there are three rows of letters and, typically, a row of numbers, augmented by various control keys such as tab, caps lock, shift, delete, backspace, function keys, etc. For a number of such devices that are small or intended to be light or portable, it is inconvenient to use a standard-sized keyboard. For example, telephones and personal digital assistants may have an array of small keys mimicking the QWERTY layout, or they may present an image of a QWERTY layout on a touch screen (see, e.g., U.S. patent application Ser. No. 12/050,171). These and similar arrangements suffer from various deficiencies: for example, often the key or key image is too small to be hit by people with ordinary or large fingers without occasionally hitting an incorrect neighboring key or image, and the arrangement is too small to allow touch typing without looking. Both of these deficiencies significantly reduce the speed of data input. Moreover, these arrangements typically add cost and size to the device, and/or reduce the area that may be devoted to displaying information to the user.

Even when the electronic device is not designed for portability, conventional keyboards may impose limitations on the effective use of the device. For example, where desk space is limited, the placement of a conventional keyboard between the user and the display device may restrict the ease of referring to and arranging books and other reference materials. In some cases, for example in an economy-class airplane seat, there may not be room for a keyboard, or required placement of the keyboard may be ergonomically undesirable. Some users, such as those who have lost the use of their fingers or for whom finger movements are difficult, are not able to use standard keyboards.

Various systems and methods have been proposed to address these deficiencies. One approach is to convert speech to text and thus allow for the elimination of any kind of keyboard. While this approach is effective for some people in some contexts, it may not be desirable to speak (for example, if privacy is desired or in a public place where speech may be distracting to others) and some people find it easier to compose by typing rather than speaking.

Another approach is to connect the device to a keyboard that is made of a flexible material that may be folded for storage and unfolded when in use. Examples of such keyboards are described in Canadian Pat. Application No. CA 2002002398804. Folding keyboards generally, however, require some support surface when being used; unfold to a large size approximating that of a conventional keyboard; and must be retrieved and connected by the user prior to use and re-stored after use. A similar approach is described in U.S. Pat. No. 6,237,846 in which a full-sized keyboard is provided that may be worn on the body, thus not requiring that the user provide an additional support surface. Such keyboards still require, however, that they be stored, carried, and retrieved and thus are not consistent with the goal of portability and ease of use typically associated with the electronic device to which they provide input.

Alternatively, keyboards have been designed to be more portable by reducing their size by using a subset of the number of keys in a conventional keyboard, where each of the keys represents two or more distinct characters distinguished by striking a control key. For example, as in U.S. Pat. Nos. 5,288,158 and 6,102,594, a same key may represent both the characters “F” and “J.” Striking, holding, or toggling the space bar distinguishes the two (just as holding the shift key, or toggling the Caps Lock key, distinguishes “F” from “f”). While such arrangements may reduce the size and weight of the keyboard, they may also require a support surface, must be stored and retrieved, and, significantly, require that a touch typist alter his or her learned behavior for selecting alphanumeric keys.

Other systems and methods, rather than focusing on reducing the size of the keyboard, do away with the keyboard and instead use devices and arrangements that mimic the arrangement of characters on a conventional keyboard. Touch screen images of keyboards have already been mentioned. Similarly, keyboard images have been projected on surfaces (including the body) and sensors employed to determine when the user's fingers strike a particular character image. However, the projecting device and sensors may add weight and size to the portable device if incorporated therein, and require separate storage and retrieval if not; the images may be required to be consistently maintained on the surface on which they are projected; and it may not be desirable or practical to project an image in a particular environment due to reasons of privacy, ambient light conditions, or other factors.

There are various systems and methods that do not employ a conventional keyboard and do not project a keyboard image. For example, U.S. Pat. Nos. 6,304,840, 5,581,484, and 5,212,372 use sensors in an attempt to map unique finger curvatures or movements to unique characters on a standard keyboard. Although such devices avoid the need to use a keyboard or project a keyboard image, they require discrimination by the sensors among multiple character-targets for each finger so that it may be determined which key the user intends to strike. To facilitate this difficult task, it may be provided, as in the '484 patent, that the fingers strike a surface (albeit without the keyboard image being present), thus requiring that a surface be conveniently available. Other approaches have been devised to make it possible to determine which specific character a finger movement is intended to effectuate. For example, U.S. Pat. No. 6,670,894 provides three thumb contacts on each thumb so that the touching of a finger against the thumb of that hand simulates the touching of the finger against a key on one of the three rows of a conventional keyboard. Although such arrangements significantly reduce the difficulty of determining which character the finger is intended to strike, they have the significant disadvantage that the deeply ingrained and essentially automated motor skills of the touch typist cannot be directly employed; rather, the user must learn a different (and often ergonomically awkward) set of movements for typing.

Systems and methods have also been devised to allow a user to select a specific character by sensing mental activity associated with an intention to move a finger or other body part. For example, a “thought translation device” is described in the article “‘Virtual Keyboard’ Controlled by Spontaneous EEG Activity,” B. Obermaier, G. R. Muller & G. Pfurtscheller, IEEE Transactions on Neural Systems and Rehabilitation Engineering, v. 11, No. 4, December 2003. The device is based on “spontaneous electroencephalogram (EEG)” signals generated by the imagining of hand, leg, or tongue movements by the user. The sensor described in the Obermaier, et al. paper seeks to detect a binary signal that is used to narrow down a single intended character from an initial set of 32 to a subsequent set of 16, then, 8, then 4, then 2, then 1, all as directed by the mental activity of the user at each stage. Advances in this line of work are described in the article “An Asynchronously Controlled EEG-Based Virtual Keyboard: Improvement of the Spelling Rate,” R. Scherer, G. R. Muller, C. Neuper, B. Graimann, & G. Pfurtscheller, IEEE Transactions on Biomedical Engineering, v. 51, No. 6, June 2004.

A common objective of known virtual (and standard) keyboards, including those described above, is to enable the user to unambiguously select a desired character. Another objective shared by most, but not all, known virtual keyboards is to enable the user to select comprehensively among the entire set of characters available on standard keyboards. Both goals seek to allow the user to quickly and accurately type whatever specific information is desired. Thus, even in known virtual keyboards with less than a full set of keys, the user may unambiguously select characters to form words that are within the alphabet provided but that may be rare or unique, such as proper nouns, fanciful words (e.g., “brite,” “kleen,” or “kwick,”), scientific or technical terms, and so on. To the extent that a full set of characters is provided, the user may unambiguously select characters to form numbers, combinations of letters and numbers (as often occurs in technical literature, e.g., “BRCA1”), combinations of alphanumeric characters with punctuation, symbols, and other special characters (e.g., “PV=nRT”), etc. These aspects of conventional virtual and standard keyboards are important in many applications. Examples include transcription of court proceedings; technical specifications or scientific articles; or formal emails, letters or legal documents. Even in routine matters, users often value precision and flexibility and thus desire the ability to form words unambiguously from unambiguous characters. If the user occasionally strikes or otherwise selects an unintended key, means are typically provided to enable the user to replace the incorrect character with the desired character so that the resulting natural-language word is unambiguously represented. Natural-language words may be considered, and are referred to herein, as “unambiguous” in the sense that they are made up of unambiguous characters, even though the words formed by the unambiguous characters may have multiple meanings (e.g., “sanction” has two meanings of almost opposite import: to approve and to punish), and various meanings may be of different grammatical forms (e.g. “fly” may be a verb or a noun).

### SUMMARY OF THE INVENTION

Notwithstanding the capabilities of standard and virtual keyboards noted above, they impose various unappreciated costs and limitations due to the implicitly assumed need to allow a user to specify words consisting of unambiguous characters. What generally has not been appreciated is that elimination of this assumption provides new opportunities for users to quickly and flexibly transfer their thoughts to electronic devices. In particular, it generally has not been appreciated that there are many situations in which a user does not require the ability to unambiguously select characters and that disambiguation may advantageously be deferred to the level of words or groups of words rather than dealt with at the level of characters. For example, rather than wishing to produce a formal and finished document, the user may wish to record the essence of a fleeting thought or observation, produce a first draft, communicate informally, or communicate in environments or under conditions in which it is not desirable or possible to focus attention on unambiguous character selection. Similarly, rather than requiring the ability to immediately communicate or record a full range of specialized words, the user may be satisfied to use a limited vocabulary. There are many other examples of situations and needs that place a premium on features other than those related to forming words from unambiguous characters. These, and other needs and features noted below, are met by the present invention.

Systems, methods, and products are described herein with respect to illustrative embodiments and implementations of the present invention that transform ambiguous physiological signals into disambiguated, or partially disambiguated, data. More specifically, in one embodiment a system for touch-typing without a keyboard is described. The system includes a sensor-converter that senses a user's finger movements and converts the sensed movements into a sequence of pseudo-characters in a pseudo-alphabet of eight, nine, or ten pseudo-characters, in which each pseudo-character is associated with two or more characters of a natural language. Also included in the system is a parser-translator that parses the sequence of pseudo-characters into a sequence of pseudo-words and translates the pseudo-words into words in the natural language. In some implementations, the translator uses a computer-accessible dictionary in which pseudo-words, either individually or in groups, are keys to dictionary entries that include natural-language words and data related to the words. In some of those implementations, that data may include one or more measures indicating a preference or ranking of the natural-language words in the dictionary entry.

In accordance with another embodiment, a system is described for a user to enter data into a user device. The system includes a physiological sensor that senses changes in the user's physiology; an ambiguous sequence generator that generates a sequence of ambiguous data based on the changes; a probabilistic disambiguator that disambiguates the ambiguous data, at least in part, to provide one or more sequences of at least partially disambiguated data; and, optionally, a verification manager that applies user-provided verification or correction data to the at least partially disambiguated data, thereby to provide disambiguated data. In some implementations of that embodiment, the changes include actual or intended finger movements by the user, wherein determination of such finger movement may be a binary determination that optionally may be based on whether a measure sensed by the physiological sensor has crossed a threshold value.

In some of such implementations, the physiological sensor may be a pressure sensor, a change of pressure sensor, a position sensor, a change of position sensor, an acceleration sensor, a change of acceleration sensor, an image detector, a proximity detector, a tilt sensor, a sound-field detector, an electromagnetic radiation detector, or an electromagnetic field detector. The physiological sensor may be positioned in proximity or with reference to the user's finger, hand, wrist, forearm, arm, and/or head. In some of those implementations, each unit of data in the sequence of ambiguous data corresponds uniquely to one of the user's fingers and corresponds ambiguously to two or more characters of a natural language such as English, German, French, Italian, Spanish, Portuguese, Russian, Esperanto, Dutch, Greek, Swedish, Finnish, Danish, Norwegian, Japanese, Chinese, Korean, Hebrew, or Latin. (As used herein, the term “natural language” may include in some implementations computer languages, which typically consist of words such as “for,” “else,” or “true”; symbols such as “=,” or “!”; and numbers.) In various embodiments, the units of data may correspond to characters found on any keyboard used to construct words of a natural language. Thus, for example, the pictorial Japanese language may be conveniently represented by the Japanese kana alphabet for use with standard computer keyboards. Although examples of various embodiments of the present invention described herein make reference to the English language, often using a QWERTY layout, it will be understood that the present invention is not limited to English or to any particular layout of keys. People throughout the world have acquired touch-typing skills in other languages and other layouts that may immediately and advantageously be applied to use of the present invention, generally without the need to acquire other such skills.

Also in some of such implementations, the ambiguous sequence generator may include an encoder that encodes the physiological changes into a machine-readable format, and a timing analyzer that analyzes the timing of the changes. The encoder and/or analyzer thereby provide the sequence of ambiguous data in the computer-readable format. In some implementations, the encoder is included in the physiological sensor. In some implementations, the timing analyzer is optional. The sequence of ambiguous data may include sequences of eight, nine, or ten different data units, each corresponding uniquely to one of the user's fingers, wherein each position in the sequence of ambiguous data may include one or more of the data units. The probabilistic disambiguator may include a parser that parses the sequence of ambiguous data into parsed ambiguous data, and a translator that translates the parsed ambiguous data into partially disambiguated data. The parsed ambiguous data may include a sequence of one or more ambiguous pseudo-words and the partially disambiguated data may include a sequence of one or more natural-language words.

The translator may include an associator that associates at least a first instance of parsed ambiguous data with an entry in at least one dictionary wherein the entry comprises a set of associated data, and, optionally may also include a curator that manages the contents of the dictionary. Also optionally included in the translator is a probabilistic analyzer that analyzes the set of associated data to provide a prioritized set of associated data. Another optional element of the translator is an output controller that formats and outputs one or more members of the set of associated data or the prioritized set of associated data to provide the partially disambiguated data. The dictionary may include a look-up table that optionally is adaptive, and the set of associated data may include one or more natural-language words and, optionally, related information including frequency-of-usage information related to the words. Either the associator, the probabilistic analyzer, or both operating independently or as a single functional unit may include an adaptive look-up table; an artificial neural network algorithm, model, or system; a Bayesian algorithm, model, or system; a Markov or Hidden Markov model; an evolutionary algorithm, model, or system; and/or a statistical or mathematical algorithm, model, or system for classifying, clustering, categorizing, or associating data. In another embodiment of the invention, a dictionary is described that may be used by the translator and optionally by other elements of the described system.

The curator in accordance with various of the preceding implementations may include a dictionary manager that manages natural-language words and related information in one or more standard dictionaries and, optionally, in one or more custom dictionaries. The curator may also include a data interface manager that provides the dictionary manager with natural-language words and, optionally, related information based at least in part on data provided by the user device, a local storage device, a remote storage device accessed over a network, or the user. Also, the translator may provide the partially disambiguated data to the user device, a storage device, or both, optionally based on a selection by the user.

In yet other embodiments of the present invention, a method or process is described that includes the acts or steps of: (a) sensing changes in a user's physiology; (b) generating a sequence of ambiguous data based on the changes; and (c) at least partially disambiguating the ambiguous data to provide one or more sequences of partially disambiguated data. In accordance with further embodiments, a computer program product is provided for instructing a computer to perform a method or process including the acts or steps of: (a) accepting data representing changes in a user's physiology; (b) generating a sequence of ambiguous data based on the data; and (c) at least partially disambiguating the ambiguous data to provide one or more sequences of partially disambiguated data. In accordance with yet additional embodiments, firmware directs a state machine to perform a method or process including the acts or steps of: (a) accepting data representing changes in a user's physiology; (b) generating a sequence of ambiguous data based on the data; and (c) at least partially disambiguating the ambiguous data to provide one or more sequences of partially disambiguated data. Also provided in accordance with the present invention is a system for a user to enter data into a user device including a physiological sensor that senses changes in the user's physiology, and a programmable logic controller that performs a method or process including the acts or steps of: (a) accepting data representing changes in the user's physiology from the physiological sensor; (b) generating a sequence of ambiguous data based on the data; and (c) at least partially disambiguating the ambiguous data to provide one or more sequences of partially disambiguated data.

In a further embodiment of the present invention, a physiological sensor is described that senses changes in a user's physiology and provides change data representing the changes to a system. The system includes an ambiguous sequence generator that generates a sequence of ambiguous data based on the change data, and a probabilistic disambiguator that disambiguates the ambiguous data, at least in part, to provide one or more sequences of at least partially disambiguated data. In some implementations, the changes include actual or intended finger movements by the user.

The above embodiments and implementations are not necessarily inclusive or exclusive of each other and may be combined in any manner that is non-conflicting and otherwise possible, whether they be presented in association with a same, or a different, embodiment or implementation. The description of one embodiment or implementation is not intended to be limiting with respect to other embodiments or implementations. Also, any one or more function, step, operation, or technique described elsewhere in this specification may, in alternative implementations, be combined with any one or more function, step, operation, or technique described in the summary. Thus, the above embodiments and implementations are illustrative rather than limiting.

### BRIEF DESCRIPTION OF THE DRAWINGS

In the drawings, like reference numerals indicate like structures and the leftmost digit of a reference numeral indicates the number of the figure in which the referenced element first appears (for example, the element 230 appears first in FIG. 2). In functional block diagrams or flowcharts, rectangles generally indicate functional elements or method steps, and parallelograms generally indicate data. These conventions, however, are intended to be typical or illustrative, rather than limiting.

FIG. 1 is a functional block diagram of one embodiment of the functional elements of a data entry system in accordance with the present invention, including a physiological sensor, an ambiguous sequence generator, a probabilistic disambiguator, and to a verification manager;

FIG. 2 is a functional block diagram of the functional elements of an illustrative embodiment of the ambiguous sequence generator of the data entry system of FIG. 1, including an encoder and a timing analyzer;

FIG. 3 is a functional block diagram of the functional elements of an illustrative embodiment of the probabilistic disambiguator of the data entry system of FIG. 1, including a parser and a translator;

FIG. 4 is a functional block diagram of the functional elements of an illustrative embodiment of the translator of FIG. 3, including an associator, a curator, a probabilistic analyzer, and an output controller;

FIG. 5 is a functional block diagram of the functional elements of an illustrative embodiment of the curator of FIG. 4, including a dictionary manager and a data interface manager;

FIG. 6A is a graphical representation of a portion of a standard QWERTY keyboard layout divided into those keys that are struck by the fingers of the left hand of a person with touch-typing skills in accordance with a typical technique, and those that are struck by the fingers of the right hand;

FIG. 6B is a graphical representation of an illustrative alphabet of pseudo-characters associated with the fingers of a user of the system of FIG. 1 or FIG. 7;

FIG. 6C is a graphical representation of one possible set of associations between ambiguous pseudo-characters and their respective unambiguous natural-language characters based on the alphabet of FIG. 6B as applied by a touch-typist to the keyboard layout of FIG. 6A;

FIG. 6D is a graphical representation of an illustrative translation of ambiguous pseudo-words into their respective unambiguous natural-language words together with related information;

FIG. 7 is a functional block diagram of a particular implementation of the data entry system of FIG. 1, including a sensor converter and a parser-translator; and

FIG. 8 is a flowchart showing one implementation of method steps practiced by a data entry system in accordance with one embodiment of the present invention.

### DETAILED DESCRIPTION

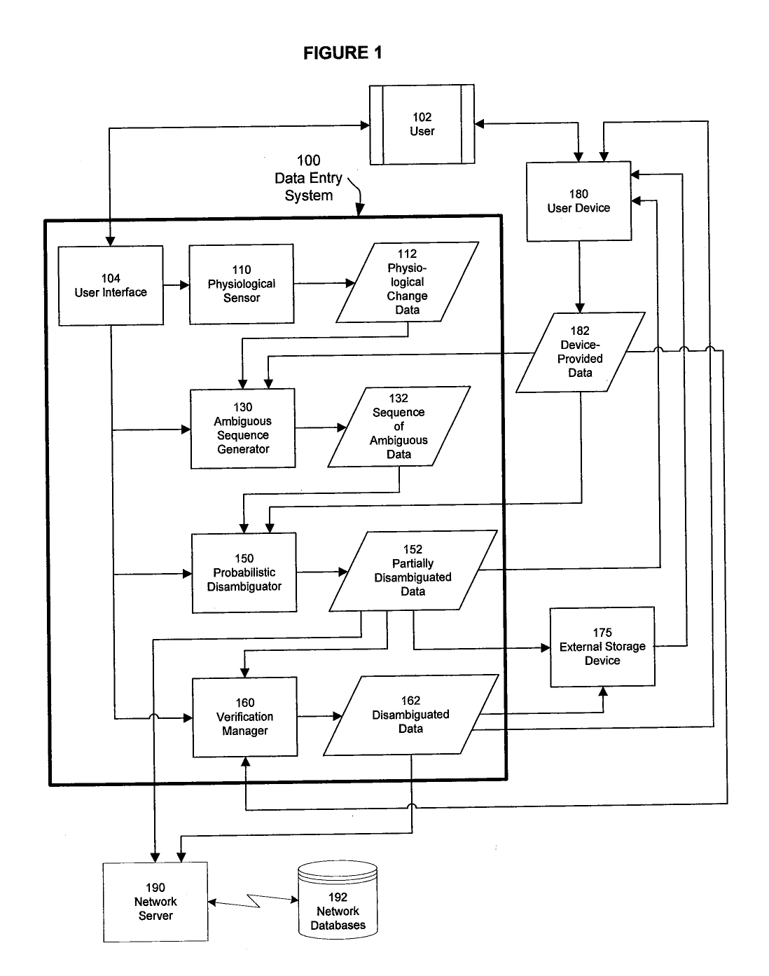

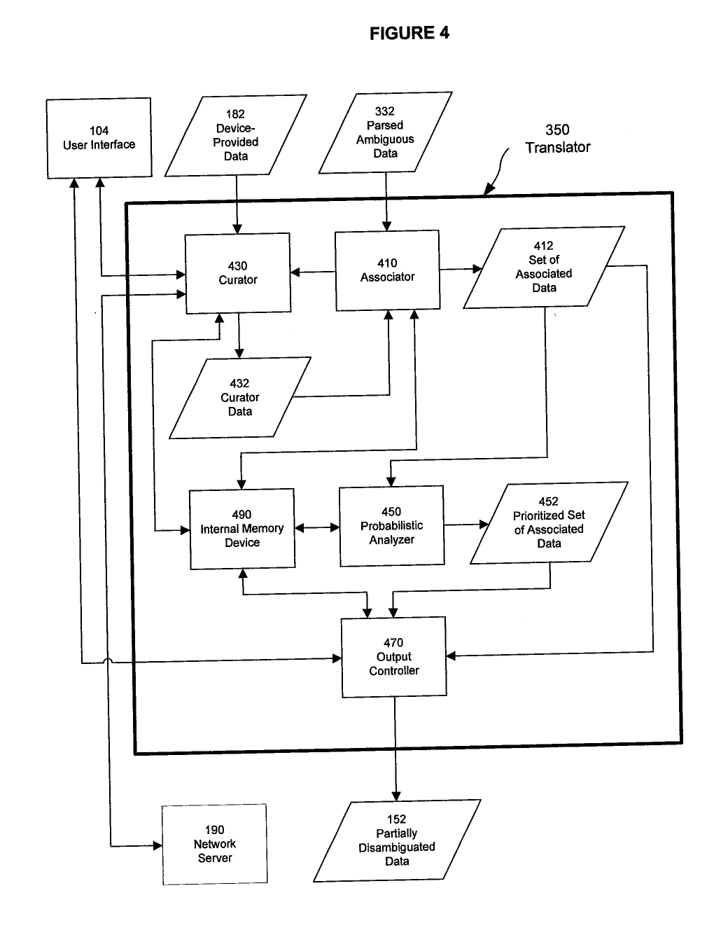

Systems, methods, and computer products in accordance with the present invention are now described with reference to an illustrative embodiment shown in FIG. 1 as data entry system 100. System 100 senses changes in the physiology of user 102 and processes those changes so as to provide partially disambiguated data 152 or disambiguated data 162 to a user device 180 and/or a data storage device such as external storage device 175, network databases 192, or, as shown in FIG. 4, internal memory device 490. For example, in some implementations system 100 senses sequences of movements in the fingers of user 102 that ambiguously correspond to natural-language characters as they would be typed by a touch typist, and converts that ambiguous data into a sequence of words (or choices of words) in that natural language. The sequence of words may then be provided by system 100 to a user device such as a mobile telephone, personal digital assistant, computer, or other electronic device; or the words may be stored for later use in an electronic device.

Advantageously, in various preferred implementations of using system 100 to enter data, user 102 may employ touch-typing mind-motor skills that can be exercised essentially subconsciously due to previous training. In particular, user 102 may simply “twitch” his/her fingers just as if using already acquired touch-typing skills and a keyboard to enter data, but without the need to interact with a keyboard. Such “twitch typing” may be done discretely and ergonomically in various stationary settings in which portability is valued, such as while seated in a lecture, and may be done in various mobile settings such as while walking, exercising, riding, or driving. Importantly, user 102 generally is not required to learn new touch-typing skills (in contrast, for example, to the special finger movements that the teachings of U.S. Pat. No. 6,670,894 require) and thus no new training generally is required. Moreover, because essentially the same skills are required for twitch typing and touch typing, user 102 may readily switch between the two seamlessly and without delay or confusion. Also advantageously, while using system 100 user 102 need not be distracted by having to register hand placement with respect to a keyboard or projected keyboard or occasionally glance at the keys or projected keys to confirm proper registration. User 102 need not store or carry a keyboard, nor does the manufacturer of the user device need to expend space, weight, or cost on a keyboard or simulated keyboard.

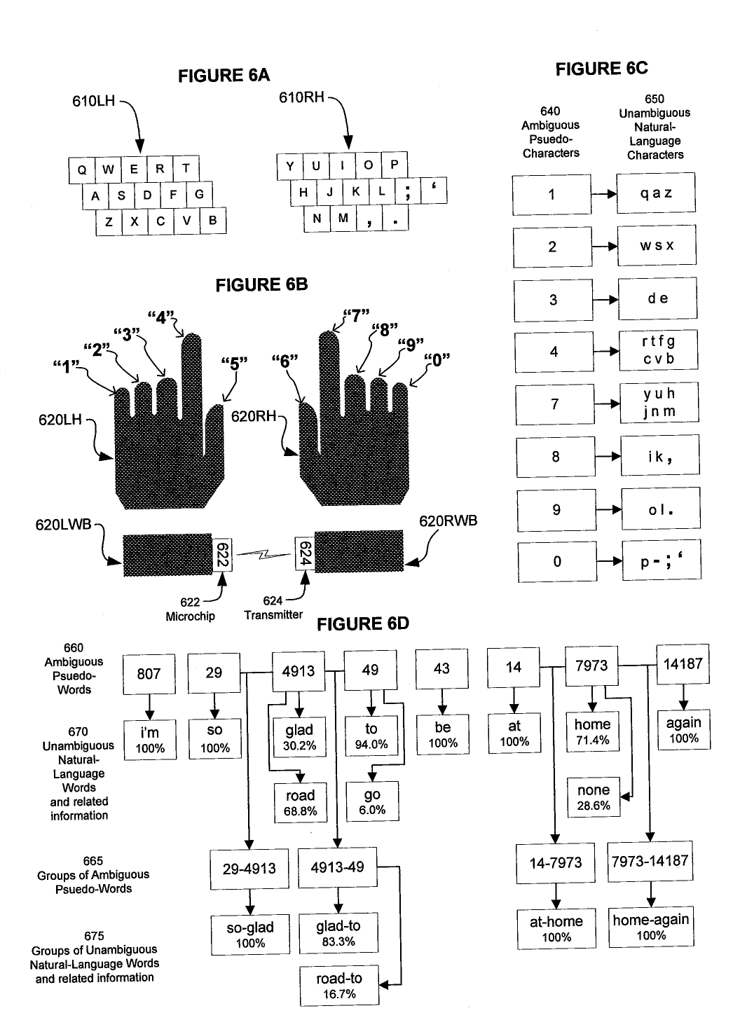

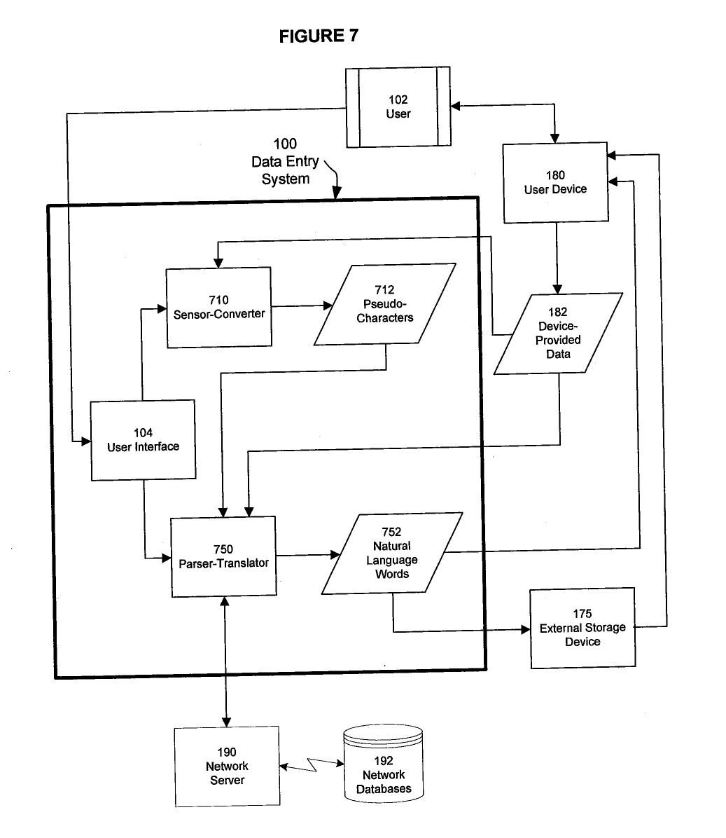

In a particular non-limiting implementation of system 100 described in greater detail below with respect to FIGS. 6A-6D and 7, system 100 includes a sensor-converter 710, a parser-translator 750, and, optionally, a user interface 104. Sensor-converter 710 senses and converts the finger movements of user 102 into pseudo-characters in an alphabet of eight, nine, or ten characters. In an alphabet of eight characters, as shown in FIG. 6B, each character may correspond to a finger other than the two thumbs. (Unless otherwise indicated, “finger” is generally used herein to refer to any of the ten fingers.) Each of the eight characters in that illustrative implementation is “ambiguous” in that each corresponds to two or more characters in a natural language. The two or more characters in this implementation correspond to keys that a touch typist would strike using the corresponding finger identified by sensor-converter 710 as having moved. For example, movement of the index finger of the left hand would be converted by sensor-converter 710 to a pseudo-character (represented for illustrative purposes by the integer “4” in FIG. 6B) that ambiguously corresponds to the characters “r,” “t,” “f,” “g,” “c,” “v,” and “b” in the so-called QWERTY layout of a keyboard in the English language. In some implementations, and as shown in the implementation of FIG. 6A, sensor-converter 710 may make the conversion based on a subset of a full QWERTY keyboard, such as by including only the 26 letters of the English language alphabet plus punctuation characters helpful in parsing words. Such a collection of characters is sometimes referred to herein as a “character reference set.”

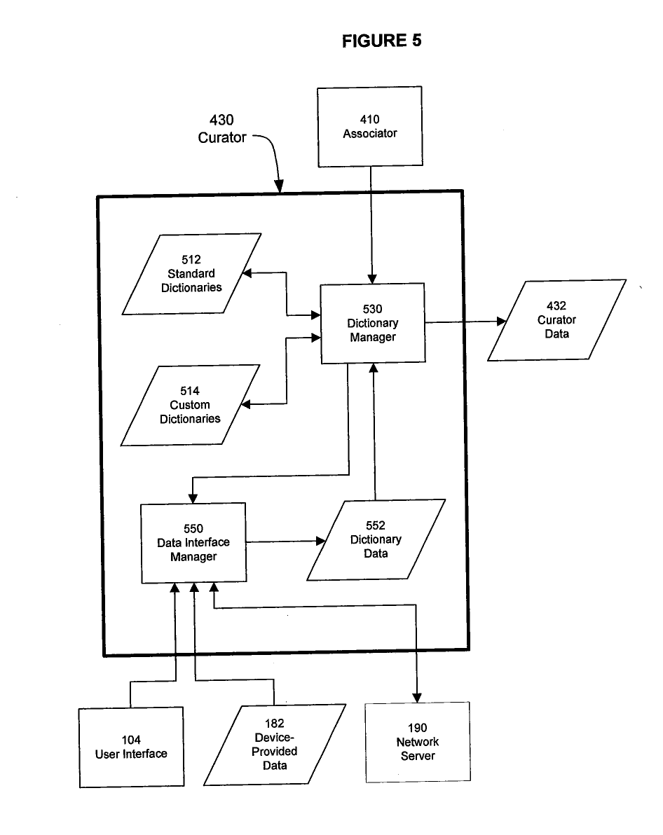

Parser-translator 750 in this implementation parses the sequence of pseudo-characters into pseudo-words, i.e., groups of pseudo-characters, based on detection by sensor-converter 710 of thumb movements, pauses in non-thumb finger movements, or other techniques described in greater detail below. Parser-translator 750 then translates the pseudo-words into sets of one or more natural-language words. For example, the pseudo-word “7973” may be translated into the English word “home,” as shown in FIG. 6D. In this illustrative implementation, the translation is done based at least in part on an association between the pseudo-word and a set of natural-language words that have been previously associated with each other as corresponding to a common pattern of finger movements, i.e., in this implementation, as having a same representation by a pseudo-word. For example, the natural-language words “of” and “or” are both twitch typed by movement of the finger represented by “9” and then by the finger represented by “4” in FIG. 6B and thus both occupy a set of natural-language words that is associated with the pseudo-word “94.” As described in greater detail below with respect to FIG. 5, this set may be included in an “entry” in a “standard dictionary” and/or “custom dictionary” based on exemplars of natural language usage.

The pseudo-word in this example corresponds to what those of ordinary skill in the art of computer software/firmware programming or database design and operation may refer to as a “key” (not to be confused with keys on a keyboard) that correlates with a “value” corresponding to the dictionary entry. Optionally, an entry may include information that prioritizes or ranks the natural-language-word members of the set, or other information related to then natural-language words in the entry. Thus, as described below in greater detail with respect to the present illustrative implementation, an entry in a custom dictionary based on the text of The Wonderful Wizard of Oz, by L. Frank Baum may include the information that “of” is more than twenty times more likely than “or” to be the natural language word intended by user 102 when sequentially moving fingers labeled 9 and 4 in FIG. 6B (the words “of” and “or” occur in that text 847 and 41 times, respectively). The weight to be accorded such probability information may be varied based, among other things, on the importance attached by user 102 to the standard and/or custom dictionary. In accordance with various embodiments of the present invention, user 102 may select and/or create standard and custom dictionaries suitable to the user's general usage or a special usage. For example, a custom dictionary may be constructed based on numerous email messages sent or received by user 102, or by other text commonly used or generated by user 102. As another non-limiting example, a custom dictionary may include proper nouns used in a particular technical field or other specialized area. Standard dictionaries may be based, for example, on lists of words defined in conventional English or other natural-language dictionaries, or a subset thereof (e.g., the 10,000 most-commonly used words). In various implementations and as further described below, user 102 may be presented with the opportunity to select the intended natural-language word from the prioritized set of words associated with the pseudo-word. In some such implementations, user interface 104 includes any of a variety of known user-interface devices and techniques, such as buttons, a touch-screen, or a microphone, so that user 102 may make the desired selection, and this information may be passed on to parser-translator 750.

As also described in greater detail below, an entry in a standard and/or custom dictionary may include groups of two or more natural-language words, and the key to that entry may be a group of two or more pseudo-words. For example, the two consecutive pseudo-words “49” and “83374847” (such pseudo-word groups hereafter represented for convenience in the format “49-83374847”) may be a key to an entry including the natural-language word group “to-identify” in a standard dictionary selected by user 102 or supplied by default with system 100. As another example, the pseudo-words “83374847-94” may be a key to an entry including “identity-of” in the standard dictionary. Such entries comprising multiple natural-language words may be constructed, as described below, from a suitably large sample of text in the desired natural language so that common combinations of multiple words may be noted. Whereas the single pseudo-word “83374847” is a key to an entry having a set comprising both the words “identify” and “identity,” the key “49-83374847” in this example may indicate that the intended natural word ambiguously represented by is likely to be “identify” and not “identity” (because the standard dictionary in this example would include information that “to identify” is more likely to occur in English-language usage than the combination “to identity”). Similarly, the key “83374847-94” may indicate that the intended natural word is likely to be “identity” and not “identify” (because the standard dictionary in this example would include information that “identity of” is more likely to occur in English-language usage than the combination “identify of”, or “identity or” which also is represented by “83374847-94”).

In the present example, probability or ranking thus may be based at least in part on the number of times that combinations of natural language words occur in exemplar texts upon which the standard or custom dictionaries are constructed. In other examples, such ranking may include considerations of, or be based entirely on, rules of morphology, syntax, semantics, and/or linguistics as employed in numerous ways well known to those of ordinary skill in the relevant arts such as the retrieval of information from databases using natural-language queries (e.g., as described in U.S. Pat. No. 6,081,774). Such techniques may be applied to combinations of consecutive words, or words within phrases or grammatical groupings, or in proximity to each other. To provide a simple grammatical example, because “identify” is a verb often preceded (immediately or closely) by the infinitive “to,” whereas “identity” is a noun that does not have this grammatically determined relationship with the word “to,” the phrase “to identify” or “to immediately identify” may be ranked as more probable than “to identity” or “to immediately identity.” As a further example, adverbs such as “immediately,” often split the infinitive in common English usage. Thus the detection of the pseudo-word “87733814397” that is a key to a dictionary entry including the word “immediately,” and the information that that word is an adverb, together with the placement of the adverb between the pseudo-word “49” (ambiguously, for example, “to”, or “go”) and the pseudo-word “83374847” (ambiguously, for example, “identity” or “identify”), may be part of a determination that the intended phrase is “to immediately identify.”

Elements of Data System 100:

Having generally described various aspects, uses, and advantages of system 100, its elements as shown in the illustrative embodiment of FIG. 1 are now described in greater detail. The elements of system 100 include a physiological sensor 110 that senses changes in the physiology of user 102, an ambiguous sequence generator 130 that generates a sequence of ambiguous data 132 based on the changes; and a probabilistic disambiguator 150 that at least partially disambiguates ambiguous data 132 to provide one or more sequences of partially disambiguated data 152. System 100 may further include a verification manager 160 that applies verification or correction data provided by user 102 to partially disambiguated data 152, thereby to provide disambiguated data 162. System 100 may also optionally include a user interface 104 so that user 102 may make selections and receive information from system 100 as described below. As noted above, user interface 104 may include any of a variety of known techniques and devices for providing information to user 102 and for accepting user selections or user information and providing the user-supplied information, typically in electronic form, so that it may be used by the functional elements of system 100. Examples include buttons, touch-screens, and audio devices such as microphones and speakers, but any other user interface now known or to be developed in the future may be used. In any instance herein in which user 102 may employ user interface 104, it will be understood that user 102 may in addition or alternatively employ a user interface provided with user device 180, and/or a separate user interface device.

There are many ways that the elements of system 100 may be physically arranged. In particular, any combination of one or more of those elements may be separated physically from any combination of the remaining elements. For example, in some implementations all elements may be physically grouped together in a microchip attached to gloves worn by user 102. In other implementations, physiological sensor 110 may be attached to such gloves and the remaining elements may be physically grouped together in a microchip placed in or on the clothing or body of user 102 or in any other convenient location. Any other combination of groupings is possible, such as having physiological sensor 110 and ambiguous sequence generator 130 physically located together (as, for example, on a glove) and the remaining elements physically separated whether grouped together or not. Any conventional device or means for transmitting and receiving information, whether over short or long distances, now known or that may be developed in the future, may be used to supply information to, from, or among the elements of system 100 as described herein. For example, currently available radio technology using transceiver microchips and appropriate data and communication protocols, for example such as specified by the Bluetooth Special Interest Group, may be used. Any other transmission technology, such as those using infrared, may also be employed. In accordance with techniques evident to those of ordinary skill in the relevant art, information between or among elements of system 100 may be sent over local computer networks, over an intranet, the Internet, or other networks so that groupings of those elements in any combination or combinations may be in physically separated locations.

As just noted, the functions carried out by the elements of system 100 may be implemented by microchips appropriately programmed or having appropriate instructions integrated therein. Thus, for example, the functions of ambiguous sequence generator 130, probabilistic disambiguator 150, and/or verification manager 160 may be carried out by or in cooperation with one or more application-specific integrated circuits (ASIC's), field-programmable gate arrays (FPGA's), or by other technologies now or later developed for implementing custom functionality on integrated circuits and like devices. Such devices generally may include one or more processors, memory units, operating systems, interface controllers, and various other components, all as will be understood and appreciated by those of ordinary skill in the computer arts. Alternatively or in addition, the functions of any or all of the elements of system 100 may be carried out on a general-purpose computer and/or on user device 180.

FIG. 6B illustrates one of many possible physical arrangements of system 100. User 102 in this example wears wristbands 620LWB and 620RWB on the left and right wrists, respectively. As described below, the wristbands are one of many possible implementations of physiological sensor 110. Microchip 622, which may for example include an ASIC, is attached to and makes electrical connection with wristband 620LWB in the illustrated example. Microchip 622 in this example carries out the functions of ambiguous sequence generator 130, probabilistic disambiguator 150, and verification manager 160, and includes a user interface 104. Microchip 622 in this example also includes a receiver for receiving transmissions from transmitter 624, which may be, e.g., a radio, infrared transmitter, or other transmitting device. Wristbands 620LWB and 620RWB detect movements of the fingers of user 102 and this information is provided via the electrical connection and the transmitter-receiver, respectively, to microchip 622 for processing as described below. Among many other arrangements, both wristbands may have transmitters for sending their information to microchip 622 located elsewhere.

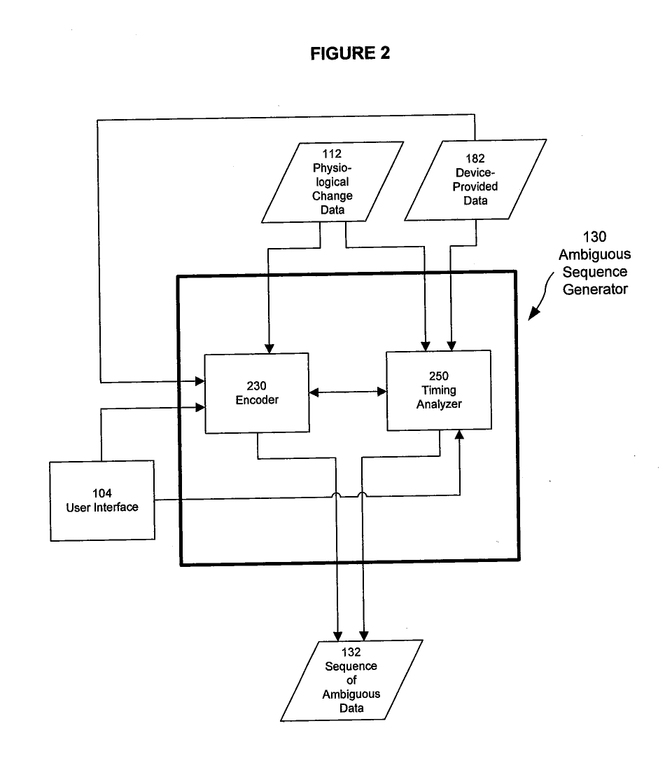

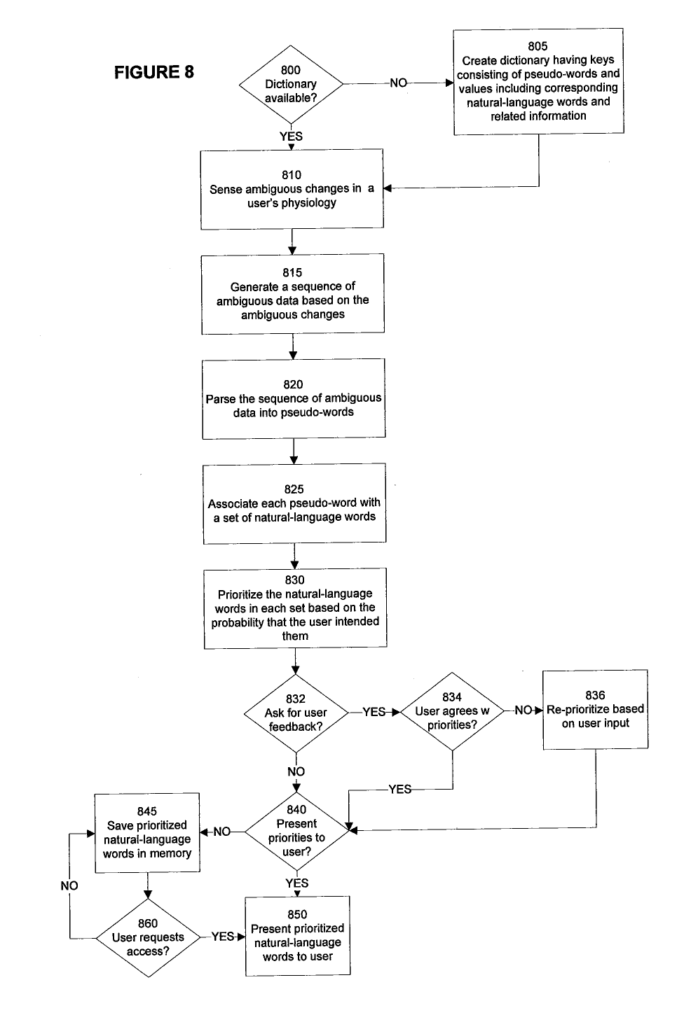

Various illustrative embodiments of these components of system 100 will now be described in greater detail in relation to FIGS. 2 through 8.

Physiological Sensor 110:

Physiological sensor 110 may, in various implementations, include sensors for detecting any change in the physiology (i.e., any change in the physical, or in some implementations manifestations of the mental, state) of user 102. In the illustrative example of touch typing, such physiological changes include finger movement as well as movement or tensing of muscles, tendons, ligaments, or skin used to prepare for or effectuate finger movement. Various types of sensors for detecting such changes may be employed. Finger movements may be detected, for example, by accelerometers attached directly to the fingers of user 102, or attached to gloves or other finger coverings worn by user 102. Examples of glove-based sensors for hand or finger movements are provided in numerous sources such as “KITTY: Keyboard Independent Touch Typing in VR,” C. Mehring, F. Keuster, K. D. Singh & M. Chen, IEEE Virtual Reality, pp. 243-244 March 2004; and “A Survey of Glove-based Input,” D. J. Sturman and D. Zeltzer, IEEE Computer Graphics & Applications, v. 14, Issue 1, pp. 30-39, January 1994. Sensor 110 may also include any of a variety of known detectors of electromagnetic signals (e.g., charge-coupled device) whether sensitive to light in the normal range of human vision or otherwise (e.g., infrared detectors). See, for example, the sensors described in a paper published on the Internet titled “The Image-Based Data Glove,” V. Pamplona, L. A. F. Fernandes, J. L. Prauchner, L. P. Nedel, & M. M. Oliveira, at vitorpamplona.com/deps/papers/2008_SVR_IBDG.pdf.

Advantageously, sensor 110 in such glove implementations in accordance with the present invention typically provides data simply indicating that a finger has moved, in contrast to some known data gloves that measure finger flex (e.g., to distinguish the row starting with “q” from the row beneath it starting with “a”) or stretch (e.g., to distinguish selecting “g” from selecting “h” with the left-hand index finger) or other indicators to determine which specific character on a standard keyboard layout is intended. As will be appreciated by one of ordinary skill in the relevant arts of sensor design, it generally is easier and cheaper to accurately and reliably detect the crossing of a binary threshold (i.e., to determine whether a finger has moved, or not) than to measure direction, reach, or other complex indicators of intended trajectory. Various glove-based implementations of sensor 110, because they generally only need to determine whether or not a finger has moved, also provide the advantage compared to some known data gloves of reducing the size and/or weight of the sensing elements and thus making the gloves less expensive to make, easier to maintain, and more comfortable to wear.

Sensor 110 may include any of a variety of known devices for detecting changes in electromagnetic fields and various other kinds of “proximity detectors,” “position detectors,” or “motion detectors,” including acoustic or other pressure-sensitive devices. In some implementations, one or more surfaces of user device 180 may be pressure or touch sensitive in accordance with known techniques so that user 102 may, for example, drum his/her fingers on a screen or casing of user device 180 and individual finger contacts may be detected. As one of many possible examples, sensor 110 could include touch-sensitive contacts on an automobile steering wheel so that user 102 could twitch type during periods when the automobile is stopped in traffic, parked, or in another situation in which user 102 would not be distracted from driving. Preferably, the contacts would not be operative when the automobile is moving. Twitch typing on the steering wheel is generally to be preferred to touch-typing on a mobile phone, GPS system, or other device that requires user 102 to divert attention to determine which particular key to strike. Twitch typing may also be preferable to voice activation in cars in noisy conditions or if user 102 is not able to speak clearly or otherwise make effective use of voice recognition systems in the automobile.

Similarly, in one particular implementation, user 102 may hold device 180 (e.g., a telephone, personal digital assistant, etc.) so that the thumbs optionally are on or above the front surface (i.e., the surface with user-interface features such as a screen or traditional mini-keyboard that is generally oriented toward the user when in use) and the remaining eight fingers are behind device 180, supporting it by touching the back surface of the case so that device 180 is nominally held in a “resting” plane roughly perpendicular to the gaze of user 102 upon the front surface. The thumbs need not be used and the remaining eight fingers may instead support device 180 while twitch typing, but additional stability, sensitivity, control, and the ability to include the thumb in twitch typing may be provided if the thumbs are also engaged. As user 102 moves a finger (and thus moves the device upon which the finger rests) in this implementation, the orientation of the device is tipped with respect to the resting plane. Any of a variety of known techniques and sensors, such as the tilt sensors commonly used in various devices such as game controllers, cameras, or telephones (e.g., the iPhone by Apple, Inc., or DROID by Motorola, Inc., that typically incorporate accelerometers, pressure sensors, temperature sensors, and/or optical elements including mirrors, in micro-electromechanical systems) detects the tilt in at least one or more planes not coincident with the resting plane. Because the fingers are spaced apart from each other, and typically those of one hand are on one side of the back of device 180 and those of the other hand on the other side, unique tilting movements may be associated with the movements of each finger or combinations of fingers. In such implementations in which one or more tilt sensors are included in user device 180, physiological change data 112 may be considered to be included in device-provided data 182 rather than (or in addition to) being provided by physiological sensor 110. In other implementations, the one or more tilt sensors may be included in a physiological sensor 110 separate from device 180. For example, rather than holding device 180, user 102 may hold, press upon, push, or otherwise interact with surfaces of sensor 110, the movements of which are detected by one or more tilt sensors.

Sensor 110 may, as noted, be positioned in physical proximity to the fingers (e.g., as noted user 102 may wear a glove to which accelerometers or other sensors are attached) or may detect finger movements at a distance (e.g., a CCD or infrared camera on a wrist, headband, or at another location whether or not attached to user 102, may create an image of finger movements or an image of reference points attached to the fingers, in which case sensor 110 typically may include an image-analysis device and/or software). As another non-limiting example, sensor 110 may include pressure, tension, or other sensors attached to a hand, wristband, or armband to detect movement or tensing of muscles, ligaments, tendons, or skin associated with or responsive to finger movements.

In various implementations, for example such as those employing tilt sensors, wristbands, or thought sensors, one or repeated training periods may be desirable so that ambiguous sequence generator 130 may learn particular patterns of signals associated for a particular user with the movements of that user's fingers. While tilt sensors and wristbands, as non-limiting examples, provide signals in accordance with the present invention such that one or more signals associated with the movement of a particular finger are distinguishable from signals associated with other fingers, the nature and pattern of those signals may differ from one individual to another. Thus, a training session may be desirable so that the signals generated by an individual's distinctive physiology or behavior (e.g., due to distinctive distribution and use of muscles and other tissue in the case of wristbands, and distinctive movement patterns in the case of tilt sensors) can be associated with the movement of particular fingers. If user device 180 includes a keyboard or other source of unambiguous data external to system 100, such device-provided data 182, as shown in FIG. 1, may be used in some implementations as a reference set to train sensor 110 and/or encoder 230 to accurately detect and categorize the patterns of signals. Device 180 during the training phase need not be the same device 180 used during non-training operation. For example, user 102 may generate training data by touch-typing words (optionally selected to optimally distinguish finger movements as detected by a wristband of the present example) using a traditional computer keyboard and computer while at the same time wearing the wristband providing ambiguous data from sensor 110.

Any of a variety of known devices and/or software may be used in such a training phase to distinguish and categorize signals from sensor 110. Examples include artificial neural networks; Bayesian algorithms, models, or systems; Markov or Hidden Markov models; evolutionary algorithms, models, or systems; and/or various known statistical or mathematical algorithms, models, or systems for classifying, clustering, categorizing, or associating data. As noted above, however, such training and classifying functions in accordance with such embodiments of sensor 110 as wristbands and tilt sensors provide information so as to allow a determination whether or not a finger has moved, not, as in some known data gloves and other sensors, which specific character on a keyboard or in another character reference set is intended (see, for example, the system for associating finger movements with specific symbols in American Sign Language, as described in Sturman, et al., at p. 36).

In some implementations, such as in which user 102 is not able to make finger movements due to a disability or other reason, or in which alternative physiological indicators are otherwise desirable, sensor 110 may be sensitive to movements of the eye or other body part. Motivated by a desire to facilitate data entry by persons with impairments that include loss of finger movement, research is currently being devoted to detecting changes in brain function or brain state resulting from mental activities. In some implementations, sensor 110 may include such a device that may be developed in the future for measuring a mental intention to move a finger even if such movement is not consummated (or is not even intended to be taken). For a description of progress in developing such a sensor, see the articles by Obermaier, et al., and by Scherer, et al., noted above. Other approaches for detecting mental activity are known, e.g., functional magnetic resonance imaging (fMRI), and such techniques for detecting stimulation of neural circuits in the brain may be employed as a sensor 110 when they are developed.

Thus, physiological sensor 110 may include in various implementations any one or any combination of a pressure sensor; a change of pressure sensor; a position sensor; a change of position sensor; an acceleration sensor; a change of acceleration sensor; an image detector; a proximity detector; a tilt sensor; a sound field detector; an electromagnetic radiation detector; an electromagnetic field detector; and/or any other device now available or to be developed in the future that is suitable for detecting movements of fingers, toes, eyes, or other body parts, or that is suitable for detecting mental activity associated with such movements or the imagining of such movements. Physiological sensor 110 may be positioned in proximity or with reference to any one or any combination of places on the body of user 102, non-limiting examples of which include a finger, hand, wrist, forearm, arm, or the head, or positioned apart from user 102.

As noted above, physiological sensor 110, particularly if physically separated from other elements of system 100, may include any known device for transmitting information (i.e., for transmitting physiological change data 112), and the receiving element (i.e., ambiguous sequence generator 130) may include any known device for receiving that information.

Ambiguous Sequence Generator 130:

Encoder 230: As shown in FIG. 2 with respect to the illustrated embodiment, ambiguous sequence generator 130 may include an encoder 230 and a timing analyzer 250. Encoder 230 encodes signals from physiological sensor 110, referred to as physiological change data 112, into a machine-readable format so that the data may be processed by other elements of system 100 that, like encoder 230, may be implemented on an ASIC or a general-purpose computer, for example. In some implementations, physiological sensor 110 may include elements that perform the functions of encoder 230. In such cases, change data 112 may be provided directly from sensor 110 to timing analyzer 250. For example, gloves or image-based systems are available that sense or detect finger movements and provide digital signals as output that may be provided to a computer via known input-output interfaces such as serial or USB ports. (See, e.g., the articles by Pamplona, et al., and by Sturman, et al., noted above.) These digital signals may encode data such as which finger has moved and when it moved. In some implementations, analog signals may convey similar information. Means for the production of such signals by physiological sensors and for providing them in digital or analog form are well known to those of ordinary skill in the relevant sensor and computer arts. As an example, construction plans and parts lists for a glove to enable one-hand typing, including the use of Bluetooth-enabled key contacts to generate data that is processed by software on a general-purpose computer running the Windows operating system from Microsoft Corporation is provided by Cemetech and published in an Internet article at cemetech.net/projects/item.php?id=16.

As noted above, encoder 230 may also, in some implementations, include any known or yet-to-be-developed training method or system for classifying, clustering, categorizing, or associating data in order to learn to recognize complex or individualistic physiological change data 112. (As noted, such methods include artificial neural networks; Bayesian algorithms, models, or systems; Markov or Hidden Markov models; and evolutionary algorithms, models, or systems, as non-limiting examples.) For instance, while various implementations of gloves directly indicate which of the fingers of user 102 has moved (e.g., a separate accelerometer is attached to each glove finger) and thus do not generally need to refine the association between sensory data and the finger generating or intended to be associated with the data, other types of sensors, such as the wristband sensor or tilt sensor arrangements noted above, may have more complex output that must be matched to an individual's distinctive anatomy or pattern of movement in order to provide optimal accuracy of finger identification. Collection of the training data may be accomplished in numerous ways such as by contemporaneously providing physiological change data 112 (e.g., as provided by a wristband sensor) and device provided data 182 (e.g., as provided by a standard keyboard typically included with user device 180 such as a telephone or computer) to the training elements of encoder 230. Also, user 102 may directly provide training data, e.g., user 102 may employ user interface 104, to provide encoder 230 with the identity of a finger moved or to be moved so that encoder 230 may correlate that finger with the physiological change data 112 previously or subsequently detected. Also, training may be done in a similar manner while user 102 is operating a general-purpose computer (other than user device 180 in this example) and the training functions of encoder 230 may be carried out by the computer running instructions and using memory resources to implement those training functions. The resulting information that correlates complex and/or individualistic physiological change data 112 to movements of specific fingers, to continue the present example, may subsequently be transferred from the general-purpose computer to encoder 230 in system 100 in accordance with known techniques.

Timing analyzer 250: Timing analyzer 250 analyzes the timing of the physiological changes so that, for example, it may be determined that the sequence of finger movements was first the index finger of the left hand, then the index finger of the right hand, and so on. In some implementations of the present example, and as described below in relation to parser 330, timing analyzer 250 may determine that two or more fingers moved closely enough together in time to indicate that user 102 intended to convey a combination of finger movements instead of serial individual finger movements. Similarly, timing analyzer 250 may determine that sufficient time has passed between consecutive finger movements to indicate that user 102 intended to convey a pause that may, for example, represent a space between words. For example, analyzer 250 may compute an average time between finger movements among such times below a threshold value (thus computing an average typing speed for user 102), and determine that times between movements that exceed this average time by some multiple are to be considered pauses intended by user 102. Analyzer 250 may similarly determine that successive finger movements more closely spaced in time than another threshold value indicates an intention by user 102 to move two or more fingers essentially at the same time, i.e., to generate a combination of fingers as sometimes referred to herein. To facilitate these determinations, an average speed for user 102 may be stored for future reference in a memory unit in or associated with analyzer 250. Alternatively, user 102 may employ user interface 104 to select a time, e.g., 1 second, after which analyzer 250 is to assume that a pause is intended, and/or a time, e.g., 10 milliseconds, such that more rapid movement of two or more fingers indicates a combination of fingers. Also, analyzer 250 may employ a predetermined default pause or combination time. Various techniques and devices for implementing all such timing determinations are familiar to those of ordinary skill in the computer and communication arts.

In various implementations, encoder 230 may operate on physiological change data and/or device-provided data 182 and then pass the result to timing analyzer 250. For example, encoder 230 may encode physiological change data 112 created by user 102 suddenly moving one or both hands to indicate a space between words, and pass this information to analyzer 250 to indicate a pause or supplement a determination by analyzer 250 as to whether a pause has occurred. In other implementations, the order may be reversed and analyzer 250 may make timing determinations and pass the information to encoder 230, or both encoder 230 and analyzer 250 may operate essentially in parallel. As shown in FIG. 2, the result of the operations of encoder 230 and analyzer 250 are referred to as a sequence of data, represented by sequence of ambiguous data 132. The word “ambiguous” in this context means that each unit of the ambiguous data is associated with a subset of a character reference set wherein the subset has more than one member. In addition, each unit of ambiguous data has its unique such subset such that no member of the subset associated with a first ambiguous data unit is included as a member of another subset associated with another ambiguous data unit. Moreover, the unit of ambiguous data does not indicate that any particular one of the members of its subset is to be associated with the unit of ambiguous data to the exclusion of any other members of its subset.

For example, in some embodiments, the sequence of ambiguous data includes sequences of eight, nine, or ten different data units, each corresponding uniquely to one of the user's fingers. In FIG. 6C, such an arrangement is shown in which eight different ambiguous data units 640 are designated “1,” “2,” “3,” “4,” “7,” “8,” “9,” and “0.” As shown in FIG. 6B, each of these eight ambiguous data units 640 is associated with a particular one of the non-thumb fingers of user 102. As also shown in the illustrative and non-limiting example of FIG. 6C, each of units 640 is associated with a subset of the natural-language characters of the keyboard layout of FIG. 6A. For example, ambiguous data unit “1” is associated with unambiguous natural-language characters “q,” “a,” and “z.” None of those natural-language characters is associated with any ambiguous data unit other than that graphically represented in FIG. 6C as “1.” The other ambiguous data units are similarly associated with their own unique subsets of unambiguous natural-language characters in accordance, in this example, with the layout of a portion of the English-language QWERTY keyboard shown in FIG. 6A and in accordance with a common touch-typing technique for striking keys with designated fingers. For example, the index finger of the left hand, represented by “4” in FIG. 6B, is used in accordance with such a technique to strike “r,” “t,” “f,” “g,” “c,” “v,” or “b,” located on the left portion 610LH of the keyboard layout of FIG. 6A. This association is shown in FIG. 6C by the connection between ambiguous data unit “4” and unambiguous natural-language characters “r,” “t,” “f,” “g,” “c,” “v,” and “b.” It will be understood that some individuals may have learned different associations between fingers and the unambiguous natural-language characters as arranged on keyboards either of the QWERTY type or of alternative designs, and the present invention encompasses any such association. Optionally, user 102 may employ user interface 104 to indicate to encoder 230 the particular associations of fingers to natural-language characters that user 102 wishes to employ, for example by selecting from a menu of known finger-character mappings, or by individually indicating the association of each finger to various characters in accordance with user 102's wishes.

Collectively, all of unambiguous natural-language characters 650, which correspond with the natural-language characters shown in portions 610LH and 610RH of the keyboard layout of FIG. 6A, constitute an implementation of a character reference set. It will be understood that these associations between ambiguous data units and unambiguous natural-language characters are illustrative and that, in other implementations, character reference sets other than the natural-language characters of a typing keyboard may be associated with ambiguous data units.

As will be noted from FIG. 6C, the thumbs in the illustrated example of FIG. 6B are not associated with ambiguous data units 640. Rather, physiological change data 112 associated with the movements of the thumbs of user 102 may be used in this example by encoder 230 to indicate a space, as typically provided by a touch-typist between words and after punctuation ending a clause or sentence. In alternative implementations, such as in which timing analyzer 250 indicates a space by detecting a pause, movement or intended movement by either or both thumbs need not be detected, e.g., the thumbs may be used merely to hold or steady user device 182. Alternatively, movement of thumbs may be detected in combinations with movements of other fingers (e.g., moved closely enough together in time so as to be recognized by timing analyzer 250 as constituting a combination of fingers) to indicate, for example, that the ambiguous character indicated by the other finger in the combination is to be capitalized. In yet other implementations, various combinations of any two or more fingers, optionally including one or both thumbs, may provide data to supplement sequence of ambiguous data 132. In such implementations having combinations detected by timing analyzer 250, it may be said that the combination constitutes a position in the sequence of ambiguous data that has two or more data units.

Probabilistic Disambiguator 150:

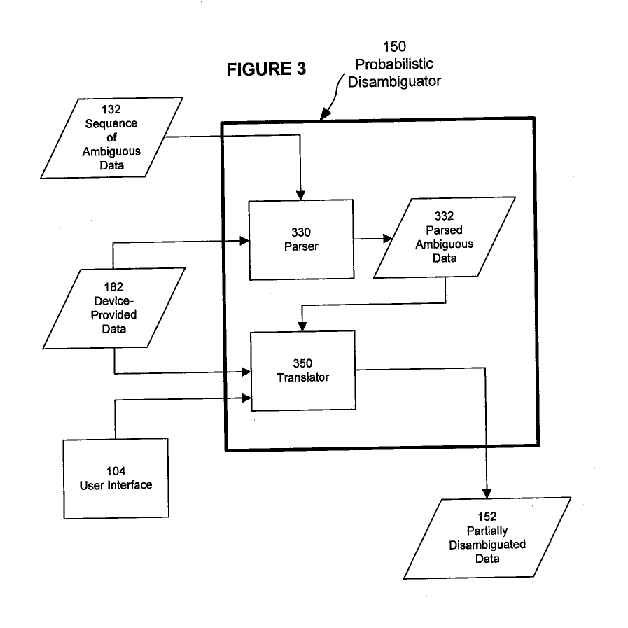

Turning now to FIG. 3, it is shown that probabilistic disambiguator 150 of illustrative system 100 includes parser 330 and translator 350. Parser 330 parses the sequence of ambiguous data 132 into parsed ambiguous data 332, and translator 350 translates the parsed ambiguous data 332 into partially disambiguated data 152.

Parser 330: Parser 330 parses, or organizes, the sequence of ambiguous data 132 into groups of ambiguous data corresponding to the start and end of words as twitch typed by user 102. As noted above with respect to the operations of encoder 230 and/or timing analyzer 250, user 102 may indicate such word groupings by, as non-limiting examples, moving a thumb (as is typically done by striking the space bar with a thumb in touch-typing techniques using conventional keyboards), by pausing, or by making a distinctive movement such as a sudden hand movement. Because these groups of ambiguous data 132 correspond to words but consist of ambiguous characters, they are sometimes referred to herein as “ambiguous pseudo-words,” or simply “pseudo-words.” Thus, for example and with reference to FIG. 6B, sensor 110 may sense the movement of fingers “6,” “2,” “9,” “6” of user 102 that ambiguous sequence generator 130 provides as the sequence of ambiguous data “6296” and parser 330 parses as the ambiguous pseudo-word 29 (in an implementation in which parser 330 recognizes movement of the right thumb as indicating a space), as shown in the second one of ambiguous pseudo-words 660 of FIG. 6D.

FIG. 6D shows an example of a sequence of ambiguous pseudo-words 660 consisting of the sequence “807,” “29,” “4913,” “49,” “43,” “14,” “7973,” and “14187.” In some implementations, parser 330 also parses, or organizes, the sequence of ambiguous data 132 into groups of ambiguous data corresponding to the start and end of groups of two or more words. Examples of such groups of ambiguous pseudo-words in combinations of two pseudo-words are “29-4913” (where the character “-” is used herein solely for convenience of description to indicate that a space was detected separating two pseudo-words), “4913-49,” “14-7973,” and “7973-14187,” as shown in groups of ambiguous pseudo-words 665 of FIG. 6D. Words 660 and 665 are examples of parsed ambiguous data 332, as shown in FIG. 3.

Translator 350: As noted, translator 350 translates parsed ambiguous data 332 into partially disambiguated data 152. As shown in the illustrative implementation of FIGS. 4 and 5, translator 350 may include an associator 410 that associates one or more instances of parsed ambiguous data 332 with respective sets of associated data 412, and, optionally may also include a curator 430 that manages the contents of one or more natural-language dictionaries 512 and/or 514 used by associator 410 to associate the instances of parsed ambiguous data 332 with their respective sets of associated data 412. Also optionally included in translator is a probabilistic analyzer 450 that analyzes the sets of associated data 412 to provide prioritized sets of associated data 452. Another optional element of the translator is an output controller 470 that formats and outputs one or more members of the prioritized sets of associated data 452 to provide the partially disambiguated data 152.

Associator 410: The functions of associator 410 of the illustrated implementation are now further described with reference to the examples provided in FIG. 6D. In this example, associator 410 receives the instance of parsed ambiguous data 332 shown in FIG. 6D as the ambiguous pseudo-word “807.” In one possible implementation, associator 410 treats the ambiguous pseudo-word as a key that is associated with values in what may be referred to as a look-up table, hash table, map, dictionary, or other term (referred to herein for convenience simply as a “dictionary”). Such dictionaries are flexibly updated and provide fast lookup as compared to arrangements in which associations involve extensive searching through a large body of information. In brief, a typical implementation includes the transformation of the keys into hash numbers that associate indexes with values by links to memory locations where the values are stored. The values constitute the entries in the dictionary. The design, construction, and use of computer-implemented dictionaries using key-value associations are well known to those of ordinary skill in the computer arts. See, for example, Professional C# 2008, C. Nagel, B. Evjen, J. Glynn, K. Watson, & M. Skinner, Wiley Publishing, Inc. (2008), pp. 278-296. Techniques for implementing such structures in firmware and in ASIC's and other microchips are also well known to those of ordinary skill in the relevant arts. Although a dictionary implementation is described herein with respect to the illustrative figures, other implementations using many other kinds of systems, methods, and devices for associating data may also be used. Many of these various implementations may combine the functions of probabilistic analyzer 450 with those of associator 410, but those functions are separately described with respect to the illustrative implementation for clarity. Thus it will be understood that in various implementations either associator 410, probabilistic analyzer 450, or both operating independently or as a single functional unit may include any one or more of an adaptive look-up table; an artificial neural network algorithm, model, or system; a Bayesian algorithm, model, or system; a Markov or Hidden Markov model; an evolutionary algorithm, model, or system; or any statistical or mathematical algorithm, model, or system for classifying, clustering, categorizing, or associating data.

With reference now to the example of a dictionary implementation, associator 410 associates parsed ambiguous data 332 including the illustrative ambiguous pseudo-word “807” with curator data 432 to provide set of associated data 412. As shown in FIG. 5 and described in greater detail below in relation to the functions of curator 430, curator data 432 includes dictionary information derived from standard dictionaries 512 and/or custom dictionaries 514. Associator 410 uses the ambiguous pseudo-word “807” as a key to link to an entry in the dictionaries of curator data 432 to identify the set of associated data 412 that includes the natural language word “i'm” and the related information that “i'm” is the only natural-language word associated with that key in the dictionaries (as shown in FIG. 6D, “i'm” accounts for 100% of the occurrences of the pseudo-word “807” in the dictionary of this example). In implementations in which curator 430 is not employed, associator 410 may alternatively associate the illustrative ambiguous pseudo-word “807” directly with standard dictionaries 512 and/or custom dictionaries 514 rather than consulting curator data 432. In either case, set of associated data 412 includes information from dictionary entries associated by associator 410 with parsed ambiguous data 332.

For purposes of illustration only, it is assumed that user 102 has employed user interface 104 to indicated a desire to use a particular custom dictionary 514 to translate the ambiguous pseudo-words 660 of this example, and not to use a standard dictionary 512. This custom dictionary is assumed to have been generated by curator 430 from the text of the English-language version of The Wonderful Wizard of Oz, by L. Frank Baum (hereafter, “Oz”).

As described below with respect to the operations of curator 430 in this illustrative implementation, curator 430 has associated each natural-language word in Oz with a pseudo-word based on the fingers that a touch-typist would use to produce the natural-language word on a QWERTY keyboard. There are 39,462 total words in Oz made up of 2,684 unique words (i.e., each of the unique words occurs one or more times so that the sum of all occurrences of all unique words is the total number of words). Curator 430 uses each of the unique words to generate a corresponding pseudo-word; for example, the natural-language word “again” generates the pseudo-word “14187” based on the numbering shown in FIG. 6B of the fingers that would be used by a touch-typist using a standard technique with a standard QWERTY keyboard. Curator 430 uses the pseudo-words as keys that provide access in the dictionary to “values,” or “entries” consisting of the associated natural-language word or words and, optionally, related information such as the frequency of use in the dictionary of the natural language words included in the entry, or another measure of weight or probability. (In other implementations, such as a neural network, it could be said that the pseudo-word is an input that stimulates the network to activate the associated natural-language word or words, and the strength of the activation and/or weight between nodes indicates related probability information.)

Of the 2,684 unique words in Oz, 92.2% would be typed by a sequence of ambiguous characters not shared by any other word in that custom dictionary. For example, and with reference to FIG. 6D, the words “i'm,” “so,” “be,” “at,” and “again” are twitch typed by fingers noted in FIG. 6B such that they may respectively be represented by the pseudo-words “807,” “29,” “43,” “14,” and “14187.” Within the limited vocabulary of Oz, there are no other natural-language words that are produced by those pseudo-words. Thus, when associator 410 uses the key “807” to find the associated entry in the Oz custom dictionary (represented by curator data 432), the entry includes in this example only the natural-language word “i'm” and the related information that that natural language word has a 100% probability of being the word intended by user 102 when sequentially moving the fingers represented by “8,” “0,” and “7” (assuming again for simplicity that system 100 is designed, or user 102 has decided, to limit curator data 432 solely to words appearing in Oz). Similarly, associator 410 retrieves the information that the natural language word “so” has a 100% probability of being intended by user 102 because the pseudo-word/key “29” is associated with a dictionary entry having only the word “so” included and that entry has the related frequency value of 100%.

However, when processing the pseudo-word/key “4913,” associator 410 determines that there are two natural words in the corresponding dictionary entry: “glad” having a frequency measure of 30.2%, and “road” having a frequency measure of 68.8%, as shown in FIG. 6D. (In the same manner as noted in the previous example, curator 430 had determined that this information be included in the dictionary entry corresponding to the pseudo-word/key “4913.”) Of the 2,684 unique natural-language words that make up the vocabulary of Oz, 6.2% share a corresponding pseudo-word with one other word, of which the pair “glad” and “road” are one example. Only 1.0% share a corresponding pseudo-word with two other words; 0.3% share a corresponding pseudo-word with three other words; and 0.3% share a corresponding pseudo-word with four or more other words. Thus, probabilistic analyzer 450, or associator 410 in optional implementations, may provide output controller 470 with prioritized sets of associated data 452 based only on the frequency information related to each of the members of the sets of associated data 412. For example, based on such data 412, output controller 470 could provide the following partially disambiguated data 152: “i'm so [road/glad] [to/go] be at [home/none] again.” Formatting the natural-language words in brackets is one of numerous ways known to those of ordinary skill in the art to indicate that more than one choice is available. Any other known presentation technique could be used. In this example, one of the choices has been highlighted to indicate that it is the more probably intended choice, based only on the information included in the relevant dictionary entries and not on further analysis by probabilistic analyzer 450. Any known technique for highlighting may be used. As shown by FIGS. 4 and 1, this data 152 may be provided to user device 180 for use by user 102, or data 152 could be stored for later use as described below in relation to external storage device 175 and/or network server 190 and network databases 192. This information may be sufficient for user 102 to discern that the sentence he/she twitch typed was “i'm so glad to be at home again” because user 102 would recognize that “i'm so road to be at home again” is nonsensical, or at least remember that that was not what was intended. In situations in which user 102 wants the translation provided by system 100 to be more accurate, user 102 may interact with verification manager 160 via user interface 104 to select the correct choices, as described below in greater detail.

In some implementations, associator 410 may access additional information in curator data 432 to improve the accuracy of the associations without intervention by user 102. In one such implementation described in greater detail below with respect to curator 430, curator data 432 includes dictionary keys and values generated by grouping multiple words that appear consecutively (or in other arrangements) within the sources used to create the dictionary. Continuing the present example of the dictionary generated from the text of Oz in the implementation illustrated by FIG. 6D, curator 430 groups together all or selected (based, for example, on grammatical, syntactic, or semantic rules) two-word combinations within the text of Oz. For example, the last sentence in that text is: “I'm so glad to be at home again.” Curator 430 groups together the pairs “i'm-so,” “so-glad,” “glad-to,” and so on. In the manner described above, curator 430 associates the keys “807-29,” “29-4913,” “4913-49,” and so on with dictionary entries including the respective pairs of natural-language words. In this process, curator 430 also encounters the phrase “The road to the City of Emeralds is paved with yellow brick,” which includes the word pair “road-to” that also is associated by curator 430 with the key “4913-49,” i.e, in this example the key “4913-49” links to a dictionary entry including the natural-word pairs “glad-to” and “road-to.” By counting the number of occurrences of these word pairs, curator 430 also determined that “glad-to” occurs 83.3% of the time in Oz and that “road-to” occurs 16.7% of the time. This information regarding frequency of occurrence may also be included in the dictionary entry accessed by the key “4913-49.” The “related information” referred to by “unambiguous natural-language words and related information 670” and by “groups of unambiguous natural-language words and related information 675” of the illustrated implementation includes this frequency information in this implementation.

Thus, analyzer 450 or associator 410, even if relying only on the frequency-of-occurrence information in the illustrative dictionary entry associated with the key “4913-49,” may indicate that the probable correct translation of what user 102 intended is “i'm so glad to” rather than “i'm so road to,” based on the frequency of usage of 83.3% and 16.7%, respectively, as recorded in the associated entry in the illustrative Oz-based dictionary. Moreover, associator 410 also may access the information that the key “29-4913,” which appears adjacent to the just-discussed word pair in the sequence of ambiguous pseudo-words 660 of this example, has a dictionary entry of only one natural-language word pair: “so glad.” There is not, for example, an entry of the pair “so-road” because that pair does not appear in the Oz text. (As noted below, the pair “so-road” may appear in another one of dictionaries 512 and/or 514 of examples other than the Oz-based dictionary, and probabilistic analyzer 450 may then provide a prioritized set of choices based on any number of methods for assessing which of the natural-language words or word-pairs is more likely the one intended by user 102.) Thus, in this illustrative example limited to the Oz text, analyzer 450 or associator 410 may determine that there is a 100% probability that “so glad” was intended by user 102 when twitch typing the ambiguous characters that were parsed into the sequence of ambiguous pseudo-words 660 of FIG. 6D. By similarly using keys consisting of pairs of pseudo-words, the natural-language word pairs “at-home” and “home-again” may be identified as intended even though the single pseudo-word key “7973” would indicate that either “home” or “none” may have been intended. (Or, as also shown by FIG. 6D, analyzer 450 or associator 410 may rely on the information related to the word “home” that it is more likely to be intended than the word “none.”) In other implementations, groups of more than two words, whether consecutively occurring or having some other morphological, syntactical, semantic, and/or linguistic relationship, may be used.

In some implementations, user 102 may employ combinations of finger movements, such as by moving a thumb at or near the same time as moving another finger, to indicate capitalization. Timing analyzer 250 may detect such combinations as noted above. For example, in reference to FIG. 6B, user 102 may move essentially together the fingers represented by the ambiguous pseudo-characters “6” and “8” to indicate a capital “I.” Timing analyzer 250 and encoder 230 process the combination to produce an ambiguous pseudo-character. The result is ambiguous because there is no information that distinguishes the intention to type “f” from the intention to type, for example, “K.” Other combinations, such as by moving a hand while moving a finger, are also possible to designate capitalization. Based on a determination by timing analyzer 250 that such a combination has occurred, encoder 230 encodes the physiological change data 112 to provide that the ambiguous pseudo-character is designated as corresponding to a capitalized form. In accordance with techniques that are known by those of ordinary skill in the computer arts, this capitalization information is preserved in sequence of ambiguous data 132 as probabilistic disambiguator 150 processes data 132 so that the corresponding partially disambiguated data 152 may be capitalized accordingly. Thus, to return to the present example with reference to FIGS. 6B, 6C, and 6D, the intended capitalization indicated by the combination of ambiguous pseudo-characters “6” and “8” is preserved (e.g., data is generated and stored) so that translator 350 associates the ambiguous pseudo-word “807” with the unambiguous natural-language word “I'm” rather than “i'm.” Also, parser 330 may provide capitalization information in special circumstances such as the beginning of sentences. Sentence structure may be discerned by conventions such as the use of double spaces to indicate sentence endings, or a possible sentence ending may be determined by probabilistic analyzer 450 based, for example, on an occurrence of the ambiguous pseudo-character “9” (which is associated with the period symbol as well as other unambiguous natural-language characters in the illustrated example of FIG. 6C) followed by one or more spaces. Also, natural-language words such as “I,” “I'm,” and the like that are routinely capitalized may be entered by curator 430 in dictionaries 512 and/or 514 in their capitalized forms.

Probabilistic analyzer 450: Turning now to the functions of probabilistic analyzer 450, it has been noted that it optionally is included in system 100 in order to analyze the sets of associated data 412 to provide prioritized sets of associated data 452. In various implementations, each set of associated data 412 includes one or more natural-language words that are associated with the pseudo-word provided to associator 410.

An objective of analyzer 450 of the illustrative example is to prioritize the natural-language words in each of set of associated data 412 so that the one most likely intended by user 102 is identified, the next most likely word is identified, and so on. The example was provided above in which associator 410 associated the pseudo-word “4913” with its set of associated data 412 consisting of the natural language words “glad” and “road,” and the related information that the frequencies of occurrence in the dictionary of curator data 432 were 30.2% and 68.8%, respectively. As also noted, probabilistic analyzer 450 may rely simply on those frequency values to rank “road” first and “glad” second in likelihood, or it may employ frequency information related to the syntactically related pseudo-word groups “29-4913” and/or “4913-49” to conclude that “glad” should be ranked first and “road” second. In some implementations, analyzer 450 may assign a confidence level to the rankings assigned to prioritized set of associated data 452. Confidence levels, and other data used by analyzer 450 to make prioritization decisions and provide related information to output controller 470, may be stored for processing in internal memory device 490. In the present example, “glad” may be assigned a very high confidence level because “so-glad” has a frequency of 100% and “glad-to” has a frequency of 83.3%, whereas “so-road” is not included in the set of associated data 412 associated with “29-4913” and “road-to” has only a 16.7% frequency. However, in various implementations, analyzer 450 may take various other factors into account in making its prioritization and confidence-level determinations.

Among the other factors that may be considered by analyzer 450 in establishing prioritization and confidence levels are: (a) relative importance and/or reliability of standard dictionaries 512 and/or custom dictionaries 514 used by dictionary manager 530 in generating curator data 432; (b) user-specific temporal information; (c) capitalization, punctuation, or various other morphological, syntactical, semantic, or grammatical information; (d) common error patterns associated with user 102 or with users generally; and (e) the possibility of other types of errors.

Examples of factor (a) include the size, diversity, or relevance of the text source from which a dictionary (i.e. a standard dictionary 512 or custom dictionary 514) was constructed. For instance, the number of total words and the number of unique words in the text of Oz, from which the custom dictionary of the example illustrated in FIG. 6D was constructed by curator 430, are both relatively small. Thus, the frequencies of occurrence of 83.3% and 16.7% noted above were determined based on a small sample (10 of 12, and 2 of 12 occurrences, respectively) of occurrences within the text of Oz. Thus, to use Oz as a sole source for constructing a standard dictionary 512 would result in many cases to misleading prioritizations because of the small sample size and because user 102 is likely to employ a substantially larger vocabulary both with respect to single words and word groups than is represented in the text of Oz. In some cases, however, a limited text such as Oz may be a very reliable source for constructing a dictionary, such as for example if user 102 were the author, Mr. Baum, and he had been engaged in twitch typing a sequel story. User 102 could, in such a case, indicate via user interface 104 and data interface manager 550 that dictionary manager 530 should assign a high reliability rating to a custom dictionary 514 built from Oz. Analyzer 450 could employ this information to weight a priority determined from such a custom dictionary 514 more heavily than a priority determined from a standard dictionary 512. Similarly, user 102 could indicate that a custom dictionary 514 built from electrical engineering texts should be weighted heavily during a particular twitch-typing session, whereas a custom dictionary 514 built from cookbooks should be weighted more heavily during another session. As another example of factor (a), curator data 432 may include the information that a custom dictionary 514 built from the text of Oz is dated in that the text was written over one hundred years ago and thus both the single-word and multiple-word vocabularies may be anachronistic in part. This information may result in analyzer 450 assigning prioritization and/or confidence levels that are either relatively low (e.g., by default, older or more stylized, specific, or eccentric texts may be de-emphasized) or relatively high (e.g., user 102 may be intending to adopt an older style of writing or to emulate Mr. Baum's style).

An example of factor (b) is that analyzer 450 may determine priority and/or confidence level based on chronology of use by user 102. Thus, in terms of the illustrated example, if user 102 has recently twitch typed “glad,” and has not twitch typed “road” in many sessions or many days, then analyzer 450 may prioritize the former over the latter. As another example of factor (b), analyzer 450 may determine that user 102 more likely intended the pseudo-word “234433” to mean “served” than “settee” because, even though both “served” and “settee” occur equally frequently in the text of Oz and thus have equal frequency measures in the illustrative custom dictionary 514 of the present example, other factors have led analyzer 450 to prioritize “served” in recent sessions. Also, as noted below in reference to the functions of curator 430 and/or verification manager 160, user 102 may indicate that “served” is to be more heavily weighted (perhaps by a specified to amount) than “settee.” Alternatively, user 102 may indicate via user interface 104 that it is unlikely that “settee” will ever be intended because it is not a part of the active vocabulary of user 102. In all such cases, and others, dictionaries 512 and/or 514 may be said to be adaptive in various implementations because the entries in them, including potentially both the natural language words and related information, may be changed based, at least in part, on experience with the use of system 100 by user 102 and/or explicit selections made by user 102.

An example of factor (c) is that a member of a set of associated data 412 may typically be capitalized because it is a proper noun or for another reason and thus, if the corresponding pseudo-word is capitalized, analyzer 450 may assign a high priority and/or confidence level to that member over other members that are not typically capitalized. However, if the pseudo-word in this example is the first word in the sentence, then analyzer 450 may either not assign a greater weight to its being capitalized, or, if syntactical or grammatical rules are considered by curator 430 in constructing curator data 432, analyzer 450 may assign a greater weight to a member that is more likely to begin a sentence than other members of the same set. Examples were already given above with respect to the use of numerous other morphological, syntactical, semantic, or grammatical usages or rules of the relevant natural language that would enable analyzer 450 to assign a higher priority and/or confidence levels; e.g., in English, the use of the infinitive “to” preceding a verb form, perhaps separated by an adverb; the likely occurrence of an adjective or a noun following the word “the”; a word beginning with a vowel likely to follow the word “an”; and so on.

Factor (d), common error patterns, may be specific to user 102 or not. An example of a common error pattern not necessarily specific to user 102, and using the example of FIG. 6B, is the twitch typing of “437” when “473” is intended. This error pattern corresponds to the touch-typing on a standard keyboard of “teh” instead of “the.” Thus, in an illustrative implementation, curator 430 may include common mistakes in a standard or custom dictionary such as by including the natural-language word “the” in a dictionary entry associated with the pseudo-word “437” as well as with “473.” Analyzer 450 may thus assign a higher priority and/or confidence level to member “the” as compared to the member “fen” (both, in this example, associated with the pseudo-word “437”) based, for example, on the high frequency of the former compared to the latter, or to its position with respect to a noun. Alternatively, if user 102 has indicated a desire to use a custom dictionary of financial terms, or a custom dictionary of Chinese texts translated into English, analyzer 450 may more heavily weigh the choice “fen,” which is a unit of currency in China. Similarly, analyzer 450 may access data it has stored in internal memory device 490 to weigh the member “fen” relatively heavily if other words in the current twitch-typing session and/or commonly used by user 102 are associated with wetlands or environmental issues (because “fen” also means in English a type of wetland). Some error patterns may be specific to user 102, e.g., user 102 may be prone to twitch typing “87473” instead of “87-473,” corresponding to omitting the space between “in” and “the” to erroneously produce “in the.” User 102 may indicate via user interface 104 that alternative translations provided in response to the pseudo-word “87473” were not what was intended and this information may be provided to dictionary manager 530. In some implementations, user 102 may also provide the correct translation so that manager 530 may include an error-correction entry in curator data 432 associating “87473” with “in-the” and analyzer 450 may make prioritization and/or confidence level determinations as described in the previous example of the pseudo-word “437.” In other implementations, rather than user 102 making the correction, analyzer 450 may note that the frequency of occurrence of “87473,” which is expected to be low based for example on entries in a standard dictionary 512, is consistent with an expected high frequency of occurrence of “87-473.” Analyzer 450 may preserve this information in internal memory device 490 for its future reference, and/or curator 430 may access this information in order to add an error-correction entry in curator data 432.

In some implementations, analyzer 450 may also consider factor (e), the possibility of other types of errors, in establishing prioritization and confidence levels. Such errors may be due to various causes such as user 102 moving a finger that wasn't intended, user 102 moving fingers in an unintended order, physiological sensor 110 incorrectly detecting which finger moved (e.g., a wristband implementation in which a pattern of muscular activation for a particular finger movement did not correspond to the pattern learned in training sessions or later adapted based on usage to represent that movement), electromagnetic interference with a signal from transmitter 624 to a receiver in microchip 622 in the example of FIG. 6B, or any other reason. Such errors may take on various forms, including for example inversions (e.g., “437” instead of “473” as in the previous example), deletions (e.g., “43” instead of “473”), insertions (e.g., “4773” instead of “473”), substitutions (e.g., “373” instead of “473”), or multiplicities and/or combinations thereof.

When encountering some such erroneous pseudo-words, associator 410 may determine that there is no corresponding entry in curator data 432 and associator 410 or analyzer 450 may so indicate to user 102 via output controller 470 and user interface 104. For example, user interface 104 may include an audio device that beeps, or a light or screen display that flashes, when an unknown pseudo-word (i.e., one that is not represented as a key in any active dictionaries 512 or 514) is encountered. Preferably, this feedback is provided in real time so that user 102 may make an immediate correction by re-twitching the intended word. (Alternatively, as noted below in relation to verification manager 160, user 102 may indicate that the pseudo-word is not an error and optionally may indicate that it was intended to represent in that instance a particular natural-language word so that curator 430 adds the pseudo-word as a new key and the natural-language word as its associated new value in a dictionary 512 or 514.)

In some cases, the error may result in a pseudo-word that does occur in curator data 432. In such cases, referred to for convenience as “hidden errors,” analyzer 450 may not detect the mistake and may provide a prioritized set of associated data 452 that does not include the intended natural-language word. Recovery from such errors is still possible in some implementations. For example, output controller 470 may provide user interface 104 with the most likely translation based on the stream of prioritized set of associated data 452 provided by analyzer 450. Based on this feedback, user 102 may detect not only unknown pseudo-words such as in the examples using a beeper above, but also mistranslated words. For example, interface 104 may include a text-to-speech converter with speaker or headphones, or a screen to display text, so that user 102 hears or sees, preferably in real time, that an error has occurred. User 102 may indicate that an error has occurred by initiating a physiological change reserved for such occurrences, for example, by moving a hand quickly to indicate that the previous word was mistranslated, or user 102 may indicate the occurrence of an error using user interface 104 by touching a screen or by speaking a word that interface 104 detects, recognizes, and converts to data. The data is provided to curator 430 so that future errors of that type may optionally be recognized, and analyzer 450 removes the erroneous natural-language word from prioritized set of associated data 452. User 102 may then re-twitch the intended word correctly. User 102 may similarly intervene when the error is due to analyzer 450 assigning first priority to a natural-language word that was not intended by user 102. Such error-correction by user 102 need not be done in real time, as further described below in relation to the functions of verification manager 160.

Other corrective actions may also be employed with respect to hidden errors. For example, in some implementations associator 410 may assume that any pseudo-word contains one or more of the error forms noted above. Associator 410 anticipates these error forms to produce tentative pseudo-words resulting in possible alternative sets of associated data 412 for inclusion in analysis by analyzer 450. For instance, associator 410 may employ the inversion error form to generate from the pseudo-word “49” the tentative alternative pseudo-word “94.” Associator 410 includes this tentative alternative pseudo-word in set of associated data 412, preferably with information identifying it as tentative, and analyzer 450 may include tentative natural words associated with “94” in the prioritized set of associated data 452. Analyzer 450 typically prioritizes the tentative natural words associated with “94” lower than ones associated with the pseudo-word “49,” and/or assigns them a lower confidence level. If, however, any of the factors (a) through (d) used by analyzer 450 indicate that one or more of the tentative natural words are more likely intended than the natural-language words associated with “49,” then the tentative natural word(s) may be weighed more heavily, including the possibility of being presented to user 102 as the intended word.

Curator 430: As noted, translator 350 as shown in the example of FIG. 4 also includes a curator 430 that manages the contents of one or more natural-language dictionaries 512 and/or 514 used by associator 410 to associate the instances of parsed ambiguous data 332 with their respective sets of associated data 412. Some of the functions of curator 430 have been described above in relation to the other functions of translator 350. One or more of the functions of curator 430 may be implemented on the same platform as other elements of system 100 (e.g., an ASIC, general purpose computer, etc.), or those functions may be implemented on a platform that is physically separate from other functions and elements. For example, the function of curator 350 includes in some implementations the creation of dictionaries 512 and/or 514. This function may be accomplished prior to user 102 having access to system 100. For example, curator 430 may be implemented in a form that includes software on a general purpose computer that may or may not be operated by or accessible to user 102, referred to herein for convenience as an “off-line” curator implementation. The operator of the general purpose computer in this off-line example creates dictionaries 512 and/or 514 that are provided as data files, or in any other computer-readable form, to system 100, which also in this example includes functions described with reference to curator 430. Updates to these dictionaries may also be provided. The dictionaries and updates may be loaded directly into system 100 in accordance with conventional techniques for loading data remotely (e.g., over a local network or the Internet) or locally, or they may be embodied in computer memory storage media that may be procured by user 102 or shipped to user 102.

Whether operated off-line, within a same physical embodiment of system 100, or otherwise, curator 430 typically will build standard dictionaries 512 from large and/or multiple texts selected either by user 102 or by the user of an off-line embodiment. These texts preferably are representative of the usage of the natural language selected by such user(s). In contrast to the limited vocabulary derived from the text of Oz in the examples above, the sources for standard dictionaries 512 may include many millions of words and word groups in the selected natural language. In that way, a more complete and representative vocabulary, with more representative frequency and other related information, may be included in dictionaries 512. Also, various collections of natural-language words, many with associated frequency statistics, are available that may be used as a source of, or to supplement, a dictionary 512 or 514.

Dictionaries 512 or 514 may also be based on spoken words (for example, by transcribing television or radio shows to capture informal or spoken speech patterns). Similarly, custom dictionaries 514 may be built on large specialized texts, such as treatises, or compilations of many years of newspaper, scholarly journal, or magazine articles, to name just a few possibilities. If user 102 wishes to ensure that a vocabulary familiar to user 102 is represented, a custom dictionary 514 may be built on a large collection of emails or other documents generated by user 102 or another source used by or familiar to user 102. Probability information included in dictionaries 512 or 514 may be based on many factors other than or in addition to frequency of occurrence in the source texts. For example, probability may also be based on the age of usage; e.g., words or word pairs that appear more frequently in recently written or spoken texts may be deemed more likely to be intended than older ones.

Dictionary manager 530, shown in FIG. 5, manages the natural-language words and related information in dictionaries 512 and 514. Various functions of manager 530 have been noted above. In particular, dictionary manager 530 generates pseudo-words from natural-language words found in the source texts provided as noted above. For instance, and with reference to the examples of FIGS. 6B and 6C, dictionary manager 530 uses such correlations to determine that the natural-language word “the” found in a source text is rendered as the pseudo-word “473.” Manager 530 determines whether the dictionary being created or modified already contains the pseudo-word “473” and, if so, whether that key is already associated with the natural-language word “the.” If that pseudo-word is not already included, manager 530 creates it and adds as the first natural-language word member of its set of associated data the natural-language word “the.” If the pseudo-word “473” already exists in the dictionary, but “the” is not yet included in its set of associated data, then manager 530 adds it. In either case, manager 530 may update frequency or other information related to the natural-language word being processed. Dictionary manager 530 may thus process in this manner millions of natural-language words and word groups from the source texts to create dictionaries 512 and/or 514. As noted, this operation may be done off-line, and typically may be done intermittently rather than each time system 100 is used. For example, a user, which may be someone other than user 102, may use manager 530 and collected source texts to generate dictionaries 512 and/or 514 and provide them initially with system 100 or periodically to user 102 so that system 100 may be updated with new, revised, or additional dictionaries. As noted, user 102 may also use curator 430 to build or edit one or more dictionaries 512 or 514 whenever desired.

In addition, manager 530 may in some implementations switch between dictionaries in one natural language to dictionaries in another natural language. Manager 530 may, for example, switch in response to a selection from user 102 conveyed via user interface 104 and data interface manager 550 and included in dictionary data 552. Alternatively, manager 530 may switch languages without intervention by user 102. For example, associator 410 may detect that a large proportion (over some threshold that may be a default value or set by user 102) of pseudo-words cannot be associated with curator data 430 derived by manager from the dictionaries 512 and 514 currently in use. Dictionary manager 530 may then select dictionaries 512 and/or 514 in another natural language for which the proportion of pseudo-words corresponding to dictionary entries surpasses the threshold. In some implementations, dictionary manager 530, via manager 550 and interface 104, presents user 102 with a list of one or more natural languages from which to select based, for example, on natural languages recently used by user 102.

Another function of dictionary manager 530 in various implementations is to enable user 102 to filter out and/or manually insert dictionary entries. For example, dictionary manager 530 may, via manager 550 and interface 104, present user 102 with a compilation of dictionary entries in which the pseudo-word/key is associated with one, two, three, or any number of natural-language words as determined by user 102. Optionally, manager 530 may also show the probabilities associated with each natural language word. User 102 may indicate that some of the natural-language words should be eliminated or reduced/increased in probability. An example was provided above with respect to the pseudo-word “234433” and its associated natural-language words “served” and “settee,” in which user 102 decided to delete “settee” as a member of the set of associated data associated with “234433.”

Also, user 102 may add a natural language word or word group to be associated with a pseudo-word, whether or not in some implementations the relationships shown between pseudo-words and associated natural language words as shown illustratively in FIGS. 6B and 6C are preserved. For example, if the natural-language word “disambiguate” does not appear in dictionary 512, user 102 may manually provide it via interface 104 and dictionary manager 530 adds it to dictionary 512 by generating the pseudo-word “382174847143,” checking to see if that pseudo-word already exists in the dictionary, and either adding “disambiguate” to the appropriate dictionary entry if the pseudo-word already exists or, if not, entering the new pseudo-word/key and its associated natural-language word “disambiguate” into dictionary 512. As noted, user 102 may also cause a dictionary entry to be created by manager 530 in which the associations between the pseudo-word consisting of pseudo-characters and the associated natural-language words consisting of natural-language characters, as such characters are illustratively shown in FIGS. 6B and 6C, do not pertain. For example, user 102 may wish to be able to twitch type special characters, numbers, or other groups of natural-language characters not included in the set of unambiguous natural-language characters 650 shown in FIG. 6C. For example, if user 102 anticipates using system 100 extensively with numbers and does not wish to spell them out, then user 102 may indicate via user interface 104 that the pseudo-word “561” should be included in dictionary 512 with the corresponding natural-language word (i.e., number, or character) “1.” Similarly, other serial use of both thumbs (fingers “5” and “6” in illustrative FIG. 6B) and another finger may be designated by user 102 to represent the other natural-language characters representing the digits 2 through 0. e.g., the pseudo-word “565” is entered into the dictionary with its corresponding value of the natural-language word “5,” and so on. Similarly, user 102 may provide special instructions to resolve difficult-to-resolve or often-encountered ambiguities. For example, the pseudo-word “84” in accordance with FIGS. 6B and 6C is correlated with the natural-language words “if” and “it,” both of which occur frequently in English. User 102 may provide via user interface 104 that dictionary manager 530 include an entry for the pseudo-word “844” that includes the natural language word “if.” User 102 may also instruct dictionary manager 530 to delete from dictionary 512 the natural language word “if” as an entry correlated with the pseudo-word “84.” Thus, user 102 may learn to twitch type “844” instead of “84” when “if” is intended and reserve the pseudo-word “84” to be correlated with “it.” Alternatively, as noted, user 102 may not provide these special instructions and rely on analyzer 450 to prioritize the alternative choices “if” and “it” depending on the various factors described above.

As noted, curator 430 may also include a data interface manager 550. In addition to various functions described above, manager 550 may provide dictionary manager 530 with natural-language words and/or related information based on data provided by user device 180 via device-provided data 182, or by devices and/or memory units located either locally (such as external storage device 175) or remotely and accessed via any of a variety of known methods such as by using an intranet, internet, or other network server 190 (e.g., a network database 192). For example, manager 550 may employ an Internet search engine, in accordance with known techniques, to find text in a particular natural language or dealing with a particular subject area and download that text to serve as source text for a standard dictionary 512 or custom dictionary 514 as described above. Manager 550 may do this searching and gathering of source text without intervention by user 102 on a random basis or based, for example, on default criteria such as all text in a specified natural language related to articles on virtual reality, all poetry by a particular poet, etc. Alternatively, user 102 may provide search criteria and/or designate particular feeds, social-networking sites, or other sites or network sources for text to generate dictionaries.

Output controller 470: In the illustrated implementation of FIG. 4, the elements of translator 350 described above cooperate to provide a prioritized set of associated data 452. Output controller 470, in accordance with known techniques, organizes and formats data 452 into a sequence of data, e.g., a string of machine-readable characters, represented in FIGS. 1 and 4 as partially disambiguated data 152. A typical sequence of data 152 in some implementations may generally be characterized for convenience as a translation in natural-language words of the sequence of parsed ambiguous data 332. For example, as noted above with reference to FIG. 6D, output controller 470 could provide the following partially disambiguated data 152: “I'm so [road/glad] [to/go] be at [home/none] again.” Or, after applying frequency information or other analysis provided by analyzer 450, data 152 may be: “I'm so glad to be at home again.” This latter form is referred to here as partially disambiguated because, even though alternative translations are not explicitly presented, any one or more word may not have been intended by user 102; rather, data 152 typically represents the best determination by analyzer 450 of what was intended. As noted, output controller may also provide audio data using any conventional text-to-speech method or device so that user 102 may hear data 152 rather than, or in addition to, viewing it. Output controller 470 may directly provide data 152 to user device 180 for presentation to user 102 using a display element, speaker, or other user interface of device 180. Alternatively, data 152 may be stored in internal memory device 490 for later presentation to user 102, and/or saved on external storage device 175 or on another remote device accessed via network server 190. For example, user 102 may be twitch typing a first draft of a new book as he/she walks along a beach, and the resulting partially disambiguated data 152 may be preserved on a network database 192 so that user 102 may download it (and optionally edit it using verification manager 160 as described below) when user 102 returns home or to the office. Any conventional communication system or one to be developed in the future may provide communication to and from network database 192, whether included in system 100 or included in user device 180 or another device accessed by system 100. As one of many possible examples, user device 180 may be capable of using a network for voice and other data transfer over mobile phones conforming with standards known informally as “3G” and more formally as International Mobile Telecommunications-2000 (IMT-2000) standards.

Verification Manager 160:

System 100 may also optionally include verification manager 160 that applies verification or correction data provided by user 102 to partially disambiguated data 152, thereby to provide disambiguated data 162, as shown in FIG. 1. As noted, in some implementations, data 152 includes alternative translations and highlighting to indicate prioritization such as in “I'm so [road/glad] [to/go] be at [home/none] again” so that user 102 may explicitly see alternative translations. In such formats, user 102 may click on the intended alternative translations to remove ambiguity, including overriding the priorities presented by system 100. Thus, user 102 clicks on “glad” and “home,” and verification manager then provides disambiguated data 162 in the form “I'm so glad to be at home again.” As noted, even though this form may be the same as represented by partially disambiguated data 152, it is no longer partially ambiguous because user 102 has verified it as what was intended (even though other translations are possible) or changed it to conform to what was intended.

In some cases, analyzer 450 may not be able to determine which of two or more possible translations is more likely, thus the likelihood of an erroneous translation is relatively high. Such cases may be highlighted and presented to user 102 by verification manager 160 so that user 102 may indicate the intended translation and the error may be avoided. For example, if user 102 twitch types the pseudo-words “473-79723-82-97-473-494734,” analyzer 450 may not be able to prioritize the possible translations “the house is on the corner” as compared to the equally possible “the mouse is on the corner.” (As noted, if the context were a discussion of real estate not involving problems of pest control, analyzer 450 could assign a higher priority or likelihood to “house” than “mouse,” but perhaps not with a high degree of confidence.)

In order to change data 152 to data 162, user 102 may employ any of a variety of known techniques such as clicking repeatedly on any word. For example, referring to the form “I'm so road to be at home again” in a previous example, user 102 may click on the word “road” to indicate that the next-highly probable alternative translation may be provided. Verification manager 160 then provides the form “I'm so glad to be at home again,” and user 102 may indicate that this is the intended translation by clicking on an “accept” button or in accordance with any other conventional technique. Similarly, user 102 may click on the word “mouse” to change “the mouse is on the corner” to “the house is on the corner.” Repeated clicks could cycle through all available alternative translations of the selected word or group of words, and in some implementations the probabilities associated with each choice could also be indicated. As also noted, user 102 may indicate that the probabilities should be changed so that, for example, “house” is heavily favored in comparison to “mouse” in future determinations by analyzer 450.

In some implementations, a physiological sensor and a computer program product have been described comprising a computer usable medium having control logic (computer software program, including program code) stored therein. The control logic, when executed by the processor, causes the processor to perform the functions of system 100 as described herein, including by executing executables performing the functions, for example, of ambiguous sequence generator 130, probabilistic disambiguator 150 and/or verification manager 160. Various conventional computer elements such as central processors, operating system, memory units, communication interfaces and controllers, user interfaces, and so on, are provided in accordance with techniques and devices known by those of ordinary skill in the computer arts. In other embodiments, these and other functions of these and other executables may be implemented partially, primarily, or completely in hardware using, for example, a hardware state machine and/or a custom-designed integrated circuit or microchip such as an ASIC. Implementation of hardware state machines, ASIC's, programmable logic controllers, and similar devices so as to perform the functions of the executables described herein will be apparent to those or ordinary skill in the relevant arts.

Having described various embodiments and implementations, it should be apparent to those skilled in the relevant art that the foregoing is illustrative only and not limiting, having been presented by way of example only. Numerous other embodiments, and modifications thereof, are contemplated as falling within the scope of the present invention.

For example, many other schemes are possible for distributing the described functions among various functional elements, and the functions of any element may be carried out in various ways in alternative embodiments. Thus, the functions of several elements may, in alternative embodiments, be carried out by fewer, or a single, element. That is, functional elements shown as distinct for purposes of illustration may be combined and/or incorporated within other functional elements in a particular implementation. For example, the functions carried out by physiological sensor 110 and ambiguous sequence generator 130 as shown in FIG. 1 may have alternatively be represented by a single element, such as was done for illustrative purposes with respect to sensor-convertor 710 of the particular embodiment shown in FIG. 7. Also, in that embodiment, the functions of parser-translator 750 generally correspond to particular implementations of the functions of probabilistic disambiguator 150. As another example, some or all of the functions carried out by associator 410 and probabilistic analyzer 450 may be carried out by one integrated device or algorithm, such as an adaptive dictionary or look-up table, artificial neural network, and/or Bayesian system (any of which may be implemented, e.g., in software, firmware, and/or hardware) that may associate and categorize/classify input based, among other things, on measures of probability stored within the network or system (either discretely or distributively) or provided from a memory source (e.g., internal memory device 490). Also, functions described as being carried out by one element in an illustrated implementation may, in other implementations, be carried out by another or other elements. For example, as noted, the encoding or training functions of encoder 230 may be carried out in some implementations by physiological sensor 110. As another non-limiting example, and as also noted, some or all of the functions of physiological sensor 110 may be incorporated in and carried out by user device 180. Any of the functional elements of system 100 may include memory units, either shared or not, remote or local, distributed or otherwise, for storing and manipulating information involved in performing the described function.

Similarly, in some embodiments, any functional element may perform fewer operations than those described with respect to the illustrated embodiment. Furthermore, the sequencing of functions, or portions of functions, generally may be altered. For example, encoder 230 may process data and provide encoded data to timing analyzer 250 for timing analysis, or the order of processing may be reversed. In addition, it will be understood by those skilled in the relevant art that control and data flows between and among functional elements and various data structures may vary in many ways from the control and data flows described above. More particularly, intermediary functional elements may direct control or data flows, and the functions of various elements may be combined, divided, or otherwise rearranged to allow parallel and/or distributed processing or for other reasons. Also, intermediate data structures or files may be used and various described data structures or files may be combined or otherwise arranged. Numerous other embodiments, and modifications thereof, are contemplated as falling within the scope of the present invention as defined by appended claims and equivalents thereto.

All patents, patent applications, books, articles, and other publications referred to herein are hereby incorporated by reference in their entireties herein for all purposes.

What is claimed is:

1. A system for touch typing without a keyboard, comprising:
a sensor-converter constructed and arranged to sense a user's finger movements and to convert the sensed movements into a sequence of pseudo-characters in a pseudo-alphabet of eight, nine, or ten pseudo-characters, wherein each pseudo-character is associated with two or more characters of a natural language; and
a parser-translator constructed and arranged to parse the sequence of pseudo-characters into a sequence of pseudo-words and to translate at least a first pseudo-word into a first set of one or more words in the natural language based at least in part on a first association between the first pseudo-word and the first set and, optionally, on a second association between at least a first group of two or more pseudo-words including the first pseudo-word and one or more groups of two or more natural-language words.

2. The system of claim 1, wherein:
the first association, and the second association if present, are predetermined and are recorded in a computer-accessible dictionary having a plurality of dictionary keys and associated dictionary entries, in which a first of the dictionary keys comprises the first pseudo-word and is associated with a first dictionary entry comprising the first set and, optionally, in which a second of the dictionary keys comprises the first group of two or more pseudo-words and is associated with a second dictionary entry comprising the one or more groups of two or more words in the natural language.

3. The system of claim 2, wherein:
the first dictionary entry further comprises one or more measure indicating a preference or ranking of natural-language words in the first set and, optionally if the second dictionary entry is present, the second dictionary entry further comprises one or more measure indicating a preference or ranking of the one or more groups of two or more natural-language words.

4. A system for a user to enter data into a user device, comprising:
a physiological sensor constructed and arranged to sense changes in the user's physiology;
an ambiguous sequence generator constructed and arranged to generate a sequence of ambiguous data based on the changes;
a probabilistic disambiguator constructed and arranged to disambiguate the ambiguous data, at least in part, to provide one or more sequences of at least partially disambiguated data; and,
optionally, a verification manager constructed and arranged to apply user-provided verification or correction data to the at least partially disambiguated data, thereby to provide disambiguated data.

5. The system of claim 4, wherein:
the physiological sensor includes any one or any combination of sensors selected from the group consisting of a pressure sensor, a change of pressure sensor, a position sensor, a change of position sensor, an acceleration sensor, a change of acceleration sensor, an image detector, a proximity detector, a tilt sensor, a sound field detector, an electromagnetic radiation detector, and an electromagnetic field detector.

6. The system of claim 4, wherein:
the physiological sensor is positioned in proximity or with reference to any one or any combination of places on the user's body selected from the group consisting of finger, hand, wrist, forearm, arm, and head.

7. The system of claim 4, wherein:
the changes comprise actual or intended finger movements by the user.

8. The system of claim 7, wherein sensing of such finger movement comprises a binary determination that optionally may be based on whether a measure sensed by the physiological sensor has crossed a threshold value.

9. The system of claim 4, wherein:
each unit of data in the sequence of ambiguous data corresponds to one and only one of the user's fingers and corresponds ambiguously to two or more characters of a natural language.

10. The system of claim 4, further comprising the user device constructed and arranged to receive, and optionally display, the at least partially disambiguated data and/or disambiguated data.

11. The system of claim 4, wherein:
the ambiguous sequence generator comprises an encoder constructed and arranged to encode the changes into a machine-readable format, and a timing analyzer constructed and arranged to analyze the timing of the changes, thereby to provide the sequence of ambiguous data in the computer-readable format.

12. The system of claim 11, wherein:
the sequence of ambiguous data comprises sequences of eight, nine, or ten different data units, each corresponding uniquely to one of the user's fingers, wherein each position in the sequence of ambiguous data may comprise one or more of the data units.

13. The system of claim 4, wherein:
the probabilistic disambiguator comprises a parser constructed and arranged to parse the sequence of ambiguous data into parsed ambiguous data, and a translator constructed and arranged to translate the parsed ambiguous data into partially disambiguated data.

14. The system of claim 13, wherein:
the parsed ambiguous data comprises a sequence of one or more ambiguous pseudo-words and the partially disambiguated data comprises a sequence of one or more natural-language words.

15. The system of claim 13, wherein:
the translator comprises an associator constructed and arranged to associate at least a first instance of parsed ambiguous data with an entry in at least one dictionary wherein the entry comprises a set of associated data, and, optionally, a curator constructed and arranged to manage the contents of the dictionary, and, optionally, a probabilistic analyzer constructed and arranged to analyze the set of associated data to provide a prioritized set of associated data, and, optionally, an output controller constructed and arranged to format and output one or more members of the set of associated data or prioritized set of associated data to provide the partially disambiguated data.

16. The system of claim 15, wherein:
the dictionary comprises a look-up table that optionally is adaptive, and the set of associated data comprises one or more natural-language words and, optionally, related information comprising frequency-of-usage information related to the words.

17. The system of claim 15, wherein:
either the associator, the probabilistic analyzer, or both operating independently or as a single functional unit are selected from the group consisting of an adaptive look-up table; an artificial neural network algorithm, model, or system; a Bayesian algorithm, model, or system; a Markov or Hidden Markov model; an evolutionary algorithm, model, or system; and a statistical or mathematical algorithm, model, or system for classifying, clustering, categorizing, or associating data.

18. A method comprising the steps of:
sensing a user's finger movements; and
converting the sensed movements into a sequence of pseudo-characters in a pseudo-alphabet of eight, nine, or ten pseudo-characters, wherein each pseudo-character is associated with two or more characters of a natural language.

19. The method of claim 18, further comprising the steps of:
parsing the sequence of pseudo-characters into a sequence of pseudo-words; and
translating at least a first pseudo-word into a first set of one or more words in the natural language.

20. The method of claim 19, wherein the translating step is based at least in part on a first association between the first pseudo-word and the first set and, optionally, on a second association between at least a first group of two or more pseudo-words including the first pseudo-word and one or more groups of two or more natural-language words.
